(19) United States
(12) Patent Application Publication
(10) Pub. No.: US 2007/0275207 A1
(43) Pub. Date: Nov. 29, 2007

(54) Carpet tile and related methods

(76) Inventors: Kenneth B. Higgins, LaGrange, GA (US); Peter C. Brazier, Leighton Buzzard (GB)

Correspondence Address: Legal Department (M-495), P.O. Box 1926, Spartanburg, SC, 29304, US

(21) Appl. No.: 11/439,937

(22) Filed: May 24, 2006

(51) Int. Cl. B32B 3/02; B32B 33/00; D05C 17/00

(52) U.S. Cl. 428/95; 428/87; 156/72

(57) ABSTRACT

Carpet tile, carpet tiles, or modular flooring include a carpet face or show surface in overlying relation to a backing of or including adjoined particle elements. In particular, but not exclusively, the carpet tiles incorporate a carpet surface or carpet face, having, for example, a pile or non-pile surface. In one embodiment, the carpet of the carpet tile has a tuft bind or precoat layer, such as a urethane precoat, disposed in overlying relation to a resilient backing formed from a mass, mixture, or slurry, for example, of particles or crumbs, bonded together in adjoined relation by a binder. One or more optional stabilizing and/or backing layers may be included. Methods of making such carpet tiles are also provided.

### TECHNICAL FIELD

The present invention relates to carpet tile, carpet tiles, modular carpet tiles, modular flooring, or the like having a carpet face or show surface in overlying relation to a backing of adjoined particle elements. In particular, but not exclusively, the invention relates to a carpet tile, modular flooring, and the like incorporating a carpet surface or carpet face, such as a tufted, bonded, flocked, needled, needle punched, woven, non-woven, knit, or the like carpet material, having, for example, a pile surface such as a loop pile, cut pile, cut and loop pile, level pile, multi-level pile, textured pile, sculpted pile, nap, and/or the like. In one embodiment, the carpet has a tuft bind or precoat layer, such as a urethane precoat disposed in overlying relation to a resilient backing formed from a mass, mixture, or slurry, for example, of virgin, recycled, recyclable, renewable, biodegradable, and/or other environmentally friendly and/or environmentally responsible particles or crumbs, for example, foam and/or rubber and/or cork and/or carpet particles bonded together in adjoined relation by an adhesive or binder, such as an MDI urethane binder. One or more optional stabilizing and/or backing layers may be disposed above, within and/or across the underside of the particle backing. Friction enhancing, adhesive, or installation facilitation materials may be added to and/or on the underside of the backing. For example, the particle backing may include voids which increase lateral grip, reduce creep, and the like. Methods of making such carpet tiles are also provided.

### BACKGROUND TO THE INVENTION

It is known to provide carpet tile with, for example, tufted or bonded carpet faces, and with backing layers formed from so-called “virgin” or “filled” foam, for example, polyurethane foam, or from “rebond” or “bonded” foam wherein chips or pieces of recycled foam are held together by a binder. Such virgin or filled foam carpet tile constructions are described, for example, in U.S. Pat. Nos. 4,522,857, 5,545,276; 5,948,500; 6,203,881; and 6,468,623 each hereby fully incorporated by reference herein. Such rebond foam carpet tile constructions are disclosed for example in British Patent GB 2 369 294B and in U.S. patent application Ser. Nos. 09/721,871, filed Nov. 24, 2000; 09/910,085, filed Jul. 20, 2001; 09/960,114, filed Sep. 21, 2001; 09/993,158, filed Nov. 16, 2001 (U.S. Published Application US 2002/0132085); 10/118,059, filed Apr. 8, 2002; 10/154,187, filed May 23, 2002; 10/198,238, filed Jul. 18, 2002; 10/209,050, filed Jul. 31, 2002 (U.S. Published Application US 2004/0022991); and, 10/313,169, filed Dec. 6, 2002 each of which are hereby incorporated by reference as if fully set forth herein.

One disadvantage of the virgin foam carpet tile constructions described above is that they tend to be rather expensive, owing to the relatively high cost of the virgin backing material. Moreover, there is a general desire by product manufacturers or purchasers to increase the recycled content of manufactured products, to recycle products, and to purchase products that can be recycled.

### SUMMARY OF THE INVENTION

The present invention provides advantages and/or alternatives over the prior art or addresses the desires for recycled content, recyclable products, or the like, by providing carpet tile, modular carpet tile, modular flooring, or the like incorporating a carpet surface or face defining a show surface and a particle or crumb backing of particles, crumbs, powder, granular, chips, pieces, and/or the like of, for example, virgin materials, recycled materials, renewable materials, recyclable materials, biobased materials, biodegradable materials, low volatile organic compound (VOC) materials, other environmentally friendly or environmentally responsible materials, and/or the like, including, for example, particles of rubber, foam, cork, wood, carpet, carpet tile, resilient flooring, hard surface flooring, textile, fabric, floor sweepings, waste products, or the like and at least one optional adhesive or binder, with one or more optional additives, and with one or more optional stabilizing and/or backing layers. Friction enhancing, adhesive, or installation facilitating materials or treatments may be added to and/or on the underside of the tile backing. For example, the particle backing may include voids which increase lateral grip, reduce creep, and the like.

The adhesive or binder may be comprised of any of several different materials. For example, the binder may be a liquid, fiber or powder binder material such as a polyurethane diphenylmethane diisocyanate (MDI) binder. Preferably it is selected from the group consisting of 4,4-methylene di-p-phenylene isocyanate (4,4′-MDI) polyurethane one- and two-component adhesives. Advantageously the binder is a solvent-free, one component (moisture curing) polyurethane adhesive. Such binder may typically be present at a level of from about 2 to 40% by weight. Alternatively the binder may be a hot melt binder and is desirably present at a level of from about 2 to 40% by weight. When elastomer crumb is included in the backing and the binder is a one component polyurethane adhesive, the binder level preferably lies in the range of about 2 to 20% by weight. Although 2 to 40% binder levels are preferred, binder levels of less than 2% and greater than 40% by weight may be employed as may be determined by experimentation. The backing may also include other additives selected, for example, from the group of anti-microbial additives, anti-flammability additives, pigments, such as iron oxide, and anti-static additives, such as carbon fibers, as well as other fillers, fibers, colorants, dyes, particles and/or the like.

The binder may be reduced or eliminated if the particles or crumbs are made of, contain or are covered by a material, such as a hot melt adhesive, which when processed, such as under heat and pressure, binds or bonds the particles together (self-binding particles).

The decorative face of such carpet tiles is preferably formed from a carpet material such as tufted, bonded, flocked, needled, needle punched, knit, woven, nonwoven, or the like construction. The carpet face may be a solid color or shade, heathered, patterned, or the like, formed of colored yarns, printed or dyed in broadloom form, printed or dyed in piece or tile form, and/or the like. In accordance with one embodiment, the carpet tile is jet dyed by a Millitron® jet dye machine by Milliken & Company of Spartanburg, S.C., U.S.A. If desired, the carpet tile may include one or more stabilizing layers. For example, a glass mat may be embedded within the carpet face, below the carpet face, in the precoat, below the precoat, in an adhesive or tiecoat layer, above or below an adhesive layer, above the particle or crumb backing, in the crumb backing, below the crumb backing, as a secondary backing, above or below a secondary backing, in a secondary backing, and/or the like. A secondary backing such as a coating film and/or textile backing layer may also be applied across the underside of the particle backing. Also, one or more friction enhancing coating or adhesive layers may be added above and/or below the secondary backing or may be the secondary backing. For example, a friction enhancing coating may be added below the crumb backing or a secondary backing. One such friction enhancing coating material is TractionBack coating offered by Milliken & Company of LaGrange, Ga., U.S.A.

According to one aspect of the present invention, there is provided a method of making environmentally friendly and/or environmentally responsible carpet tile with a carpet surface and a crumb or particle backing preferably having a substantial percentage of, for example, recycled, recyclable, biobased, biodegradable, renewable, environmentally friendly, and/or environmentally responsible material. In a potentially preferred practice, the method includes mixing particles or crumbs of virgin, recycled and/or renewable materials of, for example, rubber and/or foam and/or cork and/or carpet (such as recycled waste carpet tile) with binder material and one or more additives, fillers, agents or compounds, depositing the particle/binder mixture in a layer, placing a carpet surface material on the particle/binder layer to form a multi-layer structure, pressing the multi-layer structure while setting the binder with, for example, time, pressure, heat and/or catalyst (such as water) so that the particles are consolidated to form a particle or crumb backing that may include voids between the pressed particles with the carpet surface material bonded to the particle backing. Also, it is to be understood that the composite tile product of the present invention can be made by either placing the carpet on top of the particle/binder mixture or by inverting the carpet and then placing the crumb/binder mixture on top of the inverted carpet. The carpet or show surface may be dyed or printed before and/or after the addition of the backing. If making more than one tile at a time, the composite is preferably cut into tiles soon after formation.

Throughout this specification the terms “particle”, “crumb”, “particles”, “crumbs”, “powder”, granules”, or “chips” are used to designate elements of, for example, virgin, recycled, renewable, recyclable, biobased, biodegradable, or other environmentally friendly or environmentally responsible materials, and/or the like materials, such as, cork, foam, rubber, wood, carpet, carpet tile, resilient flooring, hard surface flooring, textiles, fabrics, floor sweepings, waste particles, and/or the like that may have been “broken down” by chopping, crushing, pulverizing, reducing, particalizing, grinding, shattering, screening, meshing, sizing, milling, densifying, masticating, mechanical grinding, cryogenic grinding, ambient grinding, granulating, hammer milling, attrition milling, classification grinding, roll milling, and/or other known suitable single or combination techniques as will be known to those of skill in the art. Thus, a particle or crumb of, for example, cork, foam, carpet, or rubber utilized within the contemplated practices can be any size in a range that includes powder, granules and chips. With reference to particles or crumbs and for the purpose of describing at least selected embodiments of the present invention, the term “powder” or “powders” means particles or crumbs that will pass a 2 mm mesh or with a maximum dimension of 2 mm in at least one dimension, as the context requires. “Granule” or “granules” means particles or crumbs that will pass a 6 mm mesh or with a maximum dimension of 6 mm in at least one dimension, as the context requires. Granules may include some powder but are generally larger than powder and have a weight average size that is near to the maximum of the size specification for the granule. “Chip” or “chips” means particles or crumbs that are larger than granules. That is, larger than 6 mm in at least one dimension, as the context requires.

The terms “environmentally friendly” materials or “environmentally responsible” materials refer to materials considered to inflict little or no harm on the environment, being friendly to the environment, favourably reducing negative-environmental impact, and the like. For example, being friendly to the environment includes: reducing the amount of materials to be land filled (disposed of in a landfill), to be incinerated, or to be otherwise dumped; using materials that would typically be discarded (recycling); using bio-based or bio-degradable materials; encapsulating waste or toxic materials; and the like.

Regardless of actual dimension, it is contemplated that the particles or crumbs are preferably a mixture of sizes with at least 25% of the particles larger than 325 mesh, more preferably at least 25% of the particles larger than 100 mesh, and most preferably at least 25% of the particles at least 50 mesh. The particles or crumbs may be characterized by substantially fractal irregular surface configuration, but may also be spherical, oval, elliptical, polygonal, rectangular, cylindrical, conical, cigar shaped, pear shaped, or the like. Also, the particles may be solid, resilient, hollow, perforated, mesh, foam, fibers, and/or the like.

It should be noted that any batch of particles normally contains a proportion smaller than the nominal particle size. Thus, for example, it has been found that rubber particles made using a granulator with a 1.5 mm screen (i.e. having holes of diameter 1.5 mm) had a distribution of sizes, measured by using standard “Endecott” test sieves (ISO3310-1:2200, BE410-1:2000, ASTM E11:95), comprising by weight 72.82% in the range 1.0-2.0 mm, 17.45% of 0.71-1.0 mm, 6.90% of 0.5-0.71 mm, 2.65% of 0.25-0.5 mm, and 0.18% of 0-0.25 mm. Therefore, in the present specification, where we refer to 1.5 mm crumb or particle size, it is meant that the particles are generated using a granulator with a 1.5 mm screen.

It is to be understood, herein, that where reference is made to “setting” the adhesive or binder, we mean any suitable method of setting the binder, for example, using techniques such as setting, cross-linking, curing, hardening, fixing, heat-setting, fusing, softening or melting then hardening or solidifying the binder, and/or the like depending on the nature of the adhesive, binder or binders. The binder may be selected from the group including thermosetting and water curable polymeric materials, adhesives, and mixtures thereof. The binder may alternatively be selected from the group including thermoplastic polymeric materials, hot melt binders, adhesives, and mixtures thereof.

According to another contemplated practice, the assembled layers are pressed at a temperature of from about 50° C. to 200° C., preferably from about 110° C. to 180° C., and most preferably approximately from about 125° C. to 177° C. The assembled layers may be pressed at high pressure, medium pressure, low pressure, extremely low pressure, or at no added pressure while being set, cured, hardened, fixed, and/or the like. For example, the composite may be pressed together in a double belt laminator (opposing compressive belts) at a pressure of between about 0.10 pounds per square inch (psi) and 100 psi, preferably between about 1 psi and 50 psi, and most preferably between about 2 psi and 20 psi. One may limit the pressure to below, for example, 15 psi, more preferably 12 psi, most preferably 10 psi, to limit any pile crush of the carpet face. Preferably, at least the crumb backing is passed through a set gap to precisely doctor or set the height of the crumb backing. One preferred practice is to pass the carpet and crumb backing below a doctor roll or mating roll which forces the carpet into the backing and sets the height of the crumb backing.

The assembly or composite may be pressed in a plurality of stages including one or more low temperature and high temperature stages. Depending on requirements, the low temperature stage may be employed first with a later higher temperature stage or vice versa. For example, if the binder is selected from the group including thermosetting and water curable polymeric materials and mixtures thereof, the assembly may be pressed in a single high temperature stage, or in a plurality of stages including at least one low temperature stage followed by at least one higher temperature stage. Alternatively, for example, if the binder is selected from the group including thermoplastic polymeric materials, hot melt binders and mixtures thereof, the assembly may be pressed in a single low temperature stage or in a plurality of stages including at least one high temperature stage followed by at least one lower temperature or cooling stage.

The assembly may be pressed, for example, between a roller and a platen, a roller and a belt, two rollers, a blanket and a belt, a blanket and a platen, a weighted blanket and a belt, a progressively weighted blanket and a belt, progressively weighted rollers and a belt, a compressive belt and a fixed belt, a pair of opposing compressive belts, and/or the like. Although a continuous process is preferred, other step wise, two stage, multi-stage, incremental indexing, or batch type process or equipment such as a heated press having an inflatable diaphragm may likewise be used when it is desired to cure the assembly under pressure.

Preferably, a continuous sheet, web or piece of carpet, carpet face, carpet material, grey (or greige) goods, precoated carpet, backed carpet, or the like may be laid on the particle/binder layer. Although a continuous sheet or web is preferred, separate carpet pieces may be laid on the particle/binder layer (for example, tile sized pieces). Alternatively, the particle/binder layer may be laid on an inverted continuous sheet, web or piece of carpet or on inverted discrete carpet pieces (for example, tile sized pieces). If desired, a layer of adhesive, primer, prepolymer, binder, or the like such as a resilient urethane or hot melt adhesive, may be disposed between the carpet face and the particle/binder layer, between the carpet face and a stabilizing layer or material, and/or between a stabilizing layer or material and the particle/binder backing to facilitate adhesion. Preferably, the carpet face has a precoat or tuft bind layer or coating which not only holds the tufts in place, but also facilitates adhesion of the carpet face to the adhesive layer and/or to the particle/binder layer. For example, the tile product may include, for example, a urethane precoat and a urethane binder, a latex precoat and urethane binder, a polyvinyl chloride (PVC) precoat and a PVC binder, a hot melt precoat and a hot melt binder, an ethylene vinyl acetate (EVA) precoat and an EVA binder, an EVA precoat and a PVC binder, or the like. Alternatively, the underside of the carpet may be coated, sprayed or treated, with a material such as a primer, prepolymer, binder, or the like to promote adhesion to the particle/binder mixture or particle/binder/additive mixture.

In the event that rubber particles are used, such rubber is preferably EPDM, SBR, or nitrile rubber. EPDM is a term used to designate a rubber mixture of which the main polymeric content is an ethylene propylene diene rubber monomer. It may also have fillers, plasticizers and other ancillary components as will be known in the rubber compounding industry. The EPDM particles may be either foam or solid particles. Preferably, the EPDM particles or crumbs are recycled weather stripping material. Nitrile rubber may also be used and is a term used to describe a compounded rubber mixture of which the main polymeric content is an acrylonitrile butadiene copolymer. It may also contain one or more fillers such as carbon black, a curing system, plasticizers, and other ancillary components. Preferably, the nitrile rubber crumbs are recycled floor mat material. SBR is a term used to designate a rubber mixture of which the main polymeric content is styrene-butadiene rubber. Tires may be mainly SBR rubber but may also include some natural rubber, filler, platicizers, and ancillary components. Other rubber materials such as SBR rubber particles, for example, recycled tires, may also be used. Other rubber or elastomer particles, such as butyl, natural, fluorocarbon, neoprene, and/or the like, may be used.

In the event that foam particles are used, such foam is preferably a urethane foam or an EPDM foam. Such foams, and in particular urethane foams, may be mechanically frothed and/or chemically blown and may be of either open or closed cell construction. Such foam particles may be polyurethane foam particles or chips or crumbs typically used in rebond polyurethane foam or bonded urethane foam. Other foams including rebond foam, waste rebond foam, nitrile foam, SBR, EVA, PVC, polyethylene, and/or other resilient materials or foam may be used.

In at least one embodiment, the particle/binder backing of the present invention has a density of less than about 1 g/cm³, preferably a density in the range of from about 0.5 to 0.9 g/cm³, more preferably in the range of from about 0.7 to 0.9 g/cm³.

In at least one embodiment, the particle backing of the present invention exhibits a tear resistance strength of at least about 0.8N/mm², more preferably, about 1.5N/mm² or higher.

Advantageously, the carpet surface or face may include or be made up of white and/or light colored yarn and/or fiber, such as synthetic or natural fibers or blends thereof, for example, Nylon 6, Nylon 6,6, wool, wool/Nylon blends, polyester, polypropylene, polyolefin, sisal, polyester, cotton, polyamide, and/or the like. Such materials may be printed or dyed with decorative surface designs, patterns, colors, shades, and/or the like. For example, carpet tile blanks or carpet tiles having a white yarn face may be pattern jet dyed.

One exemplary object of the present invention is the provision of a carpet tile or modular flooring having a carpet face and a particle backing.

Another object of the present invention is the provision of a carpet tile having a carpet face, a particle backing layer and a secondary backing.

Yet another object of the present invention is the provision of a method of making a carpet tile or modular flooring having a carpet face and a particle backing.

A more particular object of the present invention is the provision of a hardback carpet tile having a carpet face and a particle backing.

Another more particular object of the present invention is the provision of a cushion back carpet tile having a carpet face and a particle cushion backing.

Yet another object of the present invention is the provision of aesthetically pleasing, environmentally friendly, and/or environmentally responsible carpet tile or the like.

Still another object of the present invention is the provision of a method of making a carpet tile having a carpet face and a particle backing.

Still yet another object of the present invention is a method of making aesthetically pleasing, environmentally friendly, and/or environmentally responsible carpet tile, modular flooring, or the like.

Other objects and further scope of the applicability of the present invention will become apparent from the detailed description to follow, taken in conjunction with the accompanying drawings wherein like parts are designated by like reference numerals.

### BRIEF DESCRIPTION OF THE DRAWINGS

The invention will now be further described by way of example only and with reference to the drawings, which are briefly described as follows:

FIG. 1 is a partial cross-sectional side elevation illustration of an exemplary carpet tile having a tufted carpet surface and a particle backing;

FIG. 2 is a partial cross-sectional side elevation view like FIG. 1 illustrating another exemplary carpet tile having a carpet surface and layered backing;

FIG. 3 is a partial cross-sectional side elevation of yet another exemplary carpet tile having a carpet surface and a layered backing;

FIG. 4 is a partial cross-sectional side elevation of still yet another exemplary carpet tile having a carpet surface and layered backing;

FIG. 5 is a partial cross-sectional side elevation of another exemplary carpet tile having a carpet surface and a layered backing;

FIG. 6 is a partial cross-sectional side elevation of yet another exemplary carpet tile having a carpet surface and a layered backing;

FIG. 7 is a partial cross-sectional side elevation of still yet another exemplary carpet tile having a carpet surface and a particle backing;

FIG. 8 is a partial cross-sectional side elevation like FIG. 7 of another exemplary carpet tile having a carpet surface and a layered backing;

FIG. 9 is a schematic side elevation view of a process line for manufacturing carpet tile, modular flooring, or the like incorporating a carpet surface and a particle backing or layered backing, such as shown, for example, in any of FIGS. 1-8, 10, 11, 13-22, or 25;

FIG. 9A is a schematic side elevation view similar to FIG. 9 illustrating an alternative process line for manufacturing carpet tile incorporating a carpet surface and a preformed particle backing layer;

FIG. 9B is a schematic side elevation view similar to FIG. 9 illustrating an alternative process line for manufacturing carpet tile having a carpet face and a particle backing or layered backing;

FIG. 10 is a partial cross-sectional side elevation view illustrating an exemplary carpet tile having a carpet surface bonded to a stabilized particle backing with an underlying backing sheet;

FIG. 11 is a partial cross-sectional side elevation view similar to FIG. 10 illustrating another exemplary carpet tile having a carpet surface bonded to a stabilized particle backing with an underlying backing sheet and a lower coating or material;

FIG. 12 is a schematic side elevation view of a process line for manufacturing carpet tile, modular flooring, or the like having the layered construction illustrated in any of FIGS. 10, 11, 14, 18, or 19 and incorporating a carpet surface bonded to a stabilized particle backing;

FIG. 12A is a schematic side elevation view similar to FIG. 12 illustrating an alternative process line for manufacturing carpet tile having, for example, the layered construction illustrated in any of FIGS. 10, 11, or 19 and incorporating a carpet surface bonded to stabilized particle backing including preformed particle backing layers;

FIG. 13 is a partial cross-sectional side elevation view of another exemplary carpet tile having a woven carpet surface and layered backing;

FIG. 14 is a partial cross-sectional side elevation view similar to FIG. 13 illustrating still another exemplary carpet tile having a carpet surface bonded to a stabilized particle backing with an underlying backing sheet;

FIG. 15 is a partial cross-sectional side elevation view similar to FIG. 13 illustrating still yet another exemplary carpet tile having a carpet surface adhesively bonded to a particle backing with an underlying backing sheet;

FIG. 16 is a partial cross-sectional side elevation view of yet another exemplary carpet tile similar to FIG. 13, incorporating a layer of adhesive bonding a fibrous backing sheet;

FIG. 17 is a partial cross-sectional side elevation view of another exemplary carpet tile similar to FIG. 16 incorporating a layer of adhesive on either side of a particle backing layer;

FIG. 18 is a partial cross-sectional side elevation view of still another exemplary carpet tile similar to FIG. 14, incorporating an additional stabilizing or reinforcement layer;

FIG. 19 is a partial cross-sectional side elevation view of yet another exemplary carpet tile similar to FIG. 13, incorporating a stabilized particle backing;

FIG. 20 is a partial cross-sectional side elevation view like FIG. 3 or 13 illustrating another exemplary carpet tile having a bonded carpet surface and a layered backing;

FIG. 21 is a top plan view illustrating a carpet tile of the present invention, incorporating a decorative show surface;

FIG. 22 is a side view taken along line 22-22 in FIG. 21;

FIG. 23 is a top plan view of another carpet tile of the present invention, incorporating a decorative show surface with outboard border zones;

FIG. 24 is a side view taken along line 24-24 in FIG. 23; and,

FIG. 25 is a partial cross-sectional side elevation view of an exemplary tile construction of the present invention illustrating an alternative manufacturing process wherein the particle backing is added over an inverted carpet structure.

### DETAILED DESCRIPTION

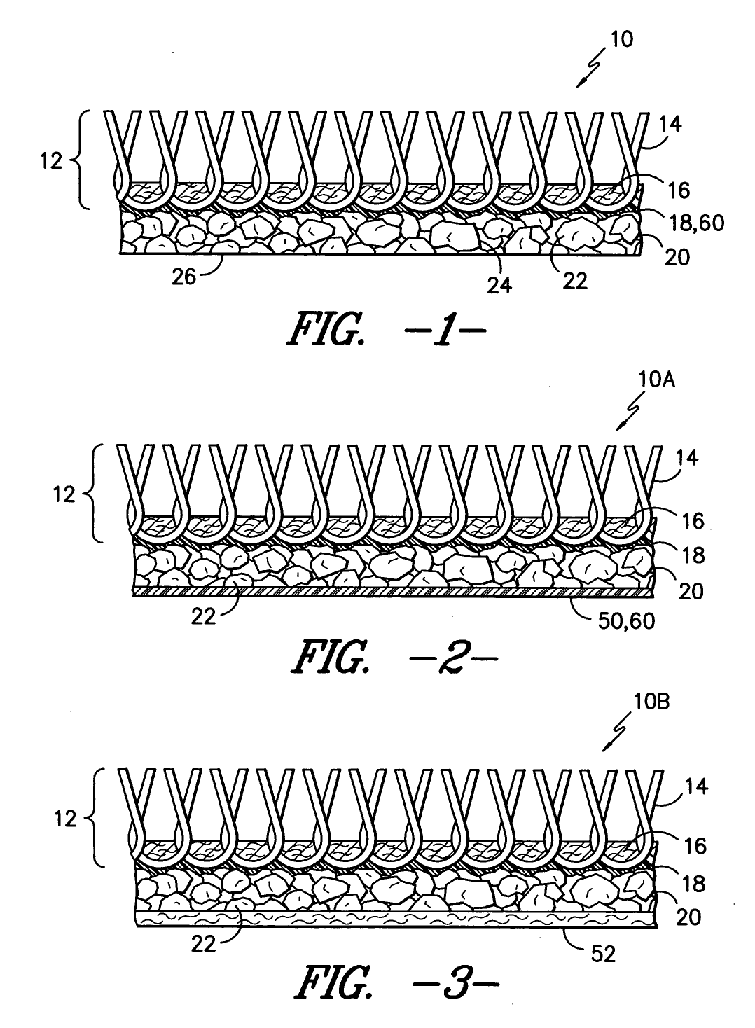

With reference to FIG. 1 of the drawings, an exemplary embodiment of a carpet tile, modular carpet tile, modular flooring, or the like 10 is illustrated in cross section. As will be appreciated, for ease of understanding, the various layers and elements are illustrated with enhanced dimensions. Thus, the illustrated dimensions do not necessarily correspond to, for example, relative thickness levels in the final construction or to actual size of the particles or crumbs.

As shown, in the illustrated exemplary embodiment, the carpet tile 10 includes a tufted, level cut pile carpet, primary carpet, carpet surface, or carpet face 12 preferably having tufts 14, a tufting substrate or primary backing 16, and a precoat or tuft bind layer or coating 18. As is well known in the tufting arts, the tufts are tufted through the primary backing and then held in place by the precoat. The carpet face or exterior carpet layer 12 is disposed in overlying relation to a single or multi-layer particle backing structure 20 as will be described further hereinafter incorporating a mass of particles or crumbs, for example, particles or crumbs of virgin, recycled, recyclable, natural, biobased, biodegradable, renewable, other environmentally friendly or environmentally responsible materials, and/or the like materials such as foam and/or rubber and/or cork and/or carpet particles or crumbs together with at least one optional adhesive or binder and may also include other additives fillers, agents, particles, fibers, and/or the like.

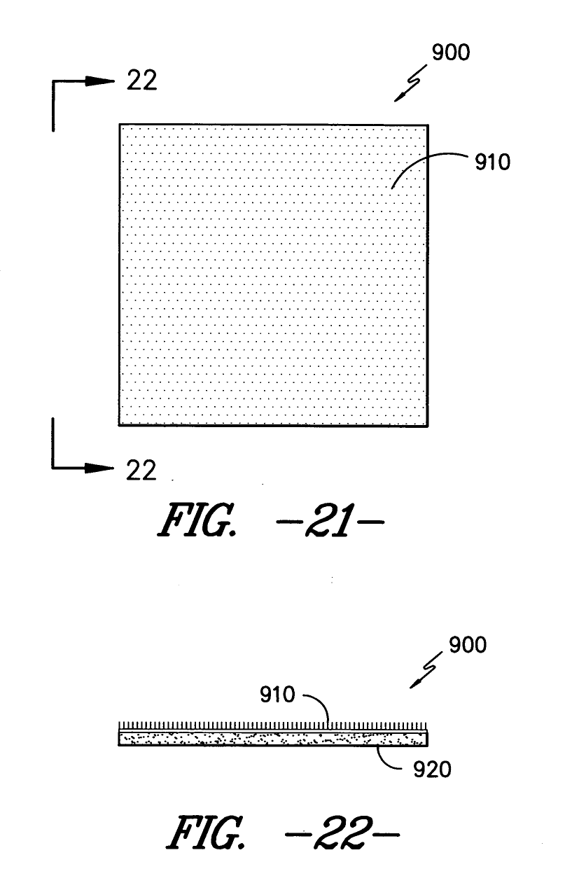

As will be appreciated, the term “carpet” used in reference to the carpet surface or carpet face 12 of the present invention is intended to refer to carpet in its general meaning including, for example, tufted, woven, bonded, nonwoven, flocked, needled, needle punched, knit, and/or the like having, for example, a pile or nap surface such as pile yarns or fibers, for example, loop pile, cut pile, cut and loop pile, level pile, multi-level pile, textured pile, sculpted pile, treated pile, and/or the like. The carpet tile, modular flooring, or the like may be or may include, for example, flat yarn, twisted yarn, textured yarn, level loop, multi-level loop, Berber, broadloom, bulked continuous filament non-texturized yarn, bulked continuous filament texturized yarn, cut pile, cut and loop pile, wool, Nylon, olefin, polyester, filament fiber, staple fiber, frieze yarn, heat-set yarn, heat-set Nylon, heat-set olefin, heat-set polyester, indoor, indoor/outdoor, outdoor, loop pile, fiber pile, yarn pile, nap, single ply yarn, multiple ply yarn, plush, velvet-plush, Saxony, natural Sisal, synthetic sisal, wool sisal, sisal like, Nylon/wool blend sisal, tufted, woven, nonwoven, knit, needle punched, bonded, fusion bonded, latex bonded, hot melt bonded, non-heat-set yarn, spun yarn, filament yarn, singles yarn, plied yarn, sheared, brushed, steamed, bulked, scanned, treated, heat treated, hot fluid treated, chemical treated, dyed, piece dyed, yarn dyed, jet dyed, tile dyed, printed, needle punched polypropylene, needle punched Nylon, needle punched multiple denier, recycled polymer yarn, recycled polymer fiber, biobased polymer yarn, biobased polymer fiber, antistatic yarn, antistatic fiber, single lobe fiber, multiple lobe fiber, high luster, low luster, acrylic fiber, acrylic yarn, acrylic, modacrylic fiber, modacrylic yarn, modacrylic, acrylic/modacrylic fiber, acrylic/modacrylic yarn, acrylic/modacrylic, precoated, tuft locked, tuft binded, anchor coated, non-precoated, non-tuft locked, non-tuft binded, non-anchor coated, backed, non-backed, antimicrobial, antimicrobial treated, antistatic, antistatic treated, attached cushion, stabilized attached cushion, Axminster, U-shaped tuft, V-shaped tuft, I-shaped tuft, including primary backing, not including primary backing, including secondary backing, not including secondary backing, including primary and secondary backing, including multiple primary backings, including multiple secondary backings, including multiple primary and secondary backings, barber pole yarn coloration, carved, base-relief carved, binded, serged, blended, border, braided, bulked, crimped, burled, reburied, cable, modular carpet, tile, carpet tile, carpet tiles, modular carpet tiles, carpet squares, carpet modules, carpet panels, carved only, carved, fluid carved, chemically carved, mechanically carved, uncarved, inset, inlayed, color fast, printed, dyed, jet dyed, injection dyed, cord, corded, cotton, cotton fiber, cotton yarn, cross dyed, cross seamed, seamed, seamless, cushioned, cushion backed, custom tufted, deep dye fiber, regular dye fiber, combined deep dye and regular dye, delustered fiber, design rug, design, design tile, patterned, differential dyed, differential dye fiber, differential dye yarn, multicolored fiber, multicolored yarn, multicolored, space dyed, space dyed yarn, stabilized, dimensionally stable, free lay, adhesive free, dope dyed, double backed, glue down, full spread, direct glue, direct glue down, drop match, drop matched, monolithic, ashler, quarter turn, checkerboard, rug in a box, Beck dyed, flocked, electrostatic flocked, embossed, extruded, extruded fiber, wet laid, air entangled, water entangled, hydro entangled, fluid entangled, fiber bonded, felted, felt, needle punched, entangled, impregnated, ribbed, veloured, textured, pattern textured, chemically backed, fibrillated, filament, continuous filament, filament yarn, monofilament, film yarn, tape fiber, tape yarn, round yarn, round fiber, velvety, velveteen, chopped fiber, free form, frieze, trackless, textured, twisted yarn, tightly twisted yarn, fringed, gel dyed, greige, grey, grey goods, hand crafted face, machine crafted, machine tufted, hand tufted, machine woven, heat bonded, heather, heathered, high low, multilevel, high and low loop, high cut pile and low loop pile, cut and loop style, inset and carved, inset only, jacquard, jacquard woven, jute, linden, grass, knitted, Leno weave, Leno weave backed, level cut loop, level loop, bright luster, semi-bright luster, semi-dull luster, dull luster, clear, white, light colored, translucent, transparent, match, set drop, set match, half drop, quarter drop, drop match, mended, metallic fiber, jointed, monochromatic, Moresque, multi-filament, multi-level cut loop pile, multi-level loop pile, napped, narrow, needled, needled felt, needle-punched, entangled and compressed, calendered, polyamide, polypropylene, solution dyed, conventional, traditional, industrial, new, unique, stain resistant, easily cleaned, durable, abrasion resistant, mildrew proof, non-allergenic, resilient, oriental face, over tufted, packed dyed, pattern cut pile, pattern loop pile, piece dyed, pigmented, pigmented yarns, pile, pile face, pile nap, non-pile, yarn face, yarn nap, yarn pile, fiber face, fiber nap, fiber pile, pile lifted, pile set, plush finish, velvet cut-pile, polymer, plastic, resin, polymer fiber, polyacrylonitrile, printed, screen printed, rotary printed, sponge printed, ink jet printed, pattern dyed, narrow loom, resist printed, rotary brushed, round wire pile, looped pile, uncut pile yarn, scribed, scrimped, seam sealed, salt-toned, two-toned, overcast stitched, shag, side seamed, skein dyed, solution dyed, yarn dyed, continuous dyed, spun, spun dyed, staple yarn, stock dyed, tack dyed, tip sheared, edge sheared, tone on tone, unitary backed, suede, velvet cut pile, wall-to-wall, graphics tufted, Wilton woven, Axminster woven, fusion bonded, servo tufted, loop pile tufted, cut pile tufted, needle punched polypropylene or polyester, non-woven polypropylene or polyester, woollen system yarn, worsted yarn, and/or the like. The above list of carpets, carpet tiles, carpet types, faces, yarns, fibers, finishes, etc. is exemplary only and not limiting. For example, the carpet tile of the present invention is not limited to any particular formation technique, yarn type, backing, or the like. In this regard, it is to be understood that carpet face may include any number of textiles, fabrics, materials, floorings, and/or the like commonly referred to as carpet, used as carpet, known as carpet, or the like. By way of example only, and not limitation, at least one process for forming a bonded carpet (like in FIG. 20) is disclosed in, for example, U.S. Pat. Nos. 5,443,881 and 5,567,257 the contents of which are each incorporated herein by reference.

The carpet 12 is preferably a pile face carpet, such as loop pile, cut pile, or cut and loop pile. By way of example only, one contemplated carpet is a tufted cut pile carpet. Another contemplated carpet is a loop pile tufted carpet. Still another contemplated carpet is a cut pile bonded carpet. Still yet another carpet is an Axminster woven carpet. Another exemplary carpet is a Wilton woven carpet. The carpet 12 may be either of solid coloration, heather and/or may have a decorative coloration, image, pattern or design woven, tufted, formed, printed and/or dyed thereon. For example, a pattern, design, color, shade, or the like may be formed by using colored yarns such as yarn dyed or solution dyed yarn, formed by piece dyeing, formed by printing, or may be jet dyed on a carpet made, for example, from white or light colored yarn or fiber Any printing, dyeing or other coloration may be done, for example, prior to carpet formation, during carpet formation, following carpet formation, prior to carpet tile, tile precursor, or tile product formation, during formation, and/or after formation.

As previously indicated, the precoat 18 preferably penetrates, encapsulates, or covers the exposed bottom of the tufts 14 and the exposed bottom of the primary backing 16 to hold the tufts 14 in place and to serve as a bond promoting agent for bonding the carpet 12 to the crumb or particle backing 20, and more particularly to bond to and be compatible with the binder or binders 24 in the backing 20. The precoat 18 is preferably compatible with the binder 24 or binders in backing 20. For example, precoat 18 may be, for example, a latex or urethane based precoat, such as a polyurethane precoat, compatible with a urethane based binder, such as, an MDI binder. The binder may be comprised of any of several different materials. For example, the binder may be a liquid, fiber or powdered binder material such as a polyurethane diphenylmethane diisocyanate (MDI) binder. Preferably it is selected from the group consisting of 4,4-methylene di-p-phenylene isocyanate (4,4′-MDI) polyurethane one- and two-component adhesives. Advantageously the binder is a solvent-free, one component (moisture curing) polyurethane adhesive. The binder may be or may include resins, polymers, plastics, prepolymers, primers, or the like. Such binder may typically be present at a level of from about 2 to 40%. Alternatively the binder may be a hot melt binder and is desirably present at a level of from about 2 to 40%. When powdered elastomer crumb is included in the backing and the binder is a one component polyurethane adhesive, the binder level preferably lies in the range from about 5 to 20%. Binder levels of less than about 2% and greater than about 40% may be employed as may be determined by routine experimentation. The backing may also include one or more additives such as anti-microbial additives, anti-flammability additives, pigments, such as iron oxide, and anti-static additives, such as carbon fibers, fillers, fibers, colorants, dyes, and/or the like.

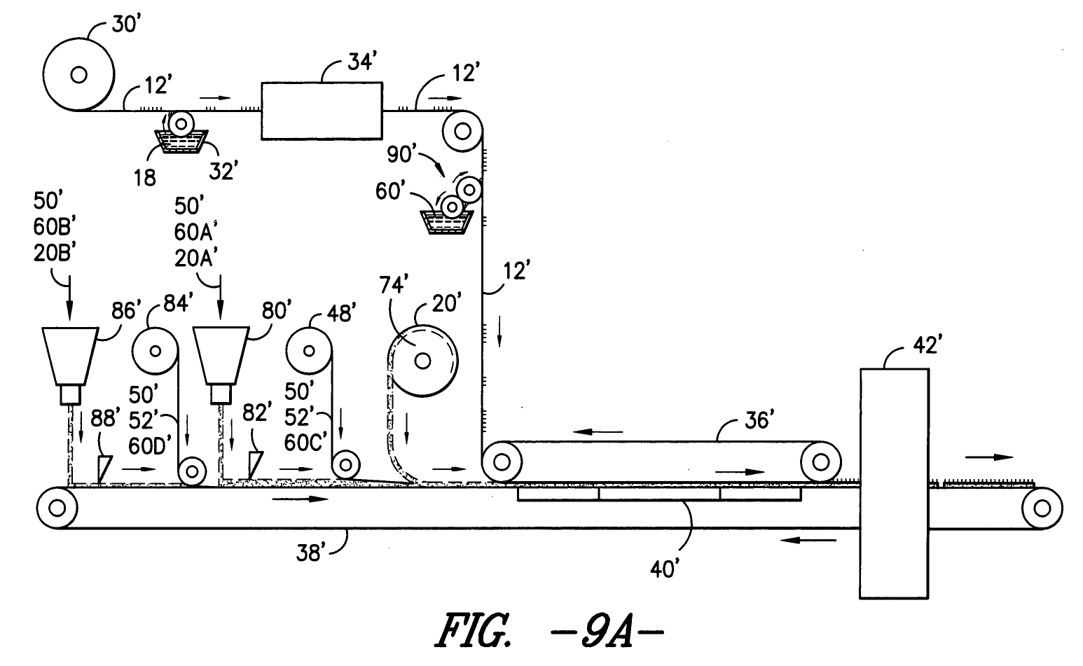

Although FIGS. 1-6, 10, 11, 13-20, and 25 show a precoat 18, a precoat 18 may not be required (see FIGS. 7 and 8). For example, the binder 24 or binders in backing 20 may be added in sufficient quantity to not only bind the particles or crumbs 22 of backing 20 to one another and make backing 20 cohesive but to also bond the backing 20 to the lower surface of carpet 12 and the binder may also serve a tuft lock function. Hence, carpet 12 may or may not include a precoat layer 18. Carpet 12 may also include multiple backings or tufting substrates, composite tufting substrates, multiple precoats or precoat layers, stabilizing layers, different piles, loop pile, textured piles, over stitching, secondary backings below the precoat such as natural or synthetic materials, for example, woven or nonwoven polypropylene or jute, urethane secondary, or the like. The precoat 18 may be a resilient thermoset or thermoplastic adhesive such as a polyurethane adhesive, latex adhesive, a bitumen hot melt adhesive, or the like applied in liquid, powder, thin film, or the like form, and which serves to not only lock the tufts 14 in place in primary backing 16, but also as a tiecoat to adhere or bond the carpet 12 to the crumb backing 20. An exemplary bitumen hot melt adhesive is described, for example, in U.S. Pat. No. 5,929,145 hereby incorporated by reference herein.

The adhesive or binder 24 on crumbs or particles 22 of particle backing 20 of FIGS. 1 and 7, may form a skin 26 of binder 24 on the bottom of the crumbs 22 of backing 20.

The add on weights of a precoat layer are usually less than the add on weights of a tiecoat or adhesive layer. For example, a typical precoat add on is about 2 to 20 oz/yd² and a typical tiecoat add on is from about 15 to 50 oz/yd². The precoat 18 of the present invention may be one or more layers of precoat material. If the precoat 18, 60 is to act as both a precoat and tiecoat, a heavier add on of precoat may be used. Also, the precoat composition or chemistry may be more like a tiecoat or adhesive when the precoat is used as a tiecoat.

As previously indicated, the backing structure 20 preferably is formed from a mass of crumbs or particles 22, such as renewable materials, recycled materials, and/or virgin materials, for example, such as cork and/or foam and/or rubber particles, preferably recycled cork and/or recycled foam and/or recycled rubber particles attached together using a binder material 24 such as a resilient or hard binder that bonds each particle to adjacent particles alone or together with other materials, agents, fillers, additives, and/or the like. The crumbs or particles 22 are preferably of a substantially irregular fractal surface geometry so as to provide a high surface area for bonding. However, cylindrical, cigar, polygonal, spheroidal, pellet, disc, rod, and/or other relatively smooth surface geometries may be used if desired. Also, the crumbs 22 may be solid, resilient, hollow, perforated, mesh, foam, fibrous, or the like. For example, crumbs 22 may be compressible and/or noncompressible spherical particles such as rubber or ceramic spheres may be employed. In the embodiment illustrated, the binder 24 also bonds the backing structure 20 to the precoat 18 on the underside of carpet layer 12. As will be appreciated, within the backing structure 20, preferably interstitial voids exist between the crumbs or particles, some of which may be partially or fully filled with the binder, fillers, additives, etc. If desired, maintaining voids and/or using a resilient binder may provide substantial resiliency and cushioning. A certain number of voids may also reduce mass, reduce cost, increase flexibility, enhance lateral grip, reduce creep, and/or the like. At least when using a liquid binder, it is preferred that each of the particles of the backing be encapsulated with at least a thin layer of binder. This aids in bonding the particles together and in bonding the backing 20 to the face composite 12.

In the event that the particles 22 of the backing structure 20 are rubber, recycled SBR rubber, recycled nitrile rubber, or recycled EPDM rubber or polymer may be preferred, and recycled EPDM rubber or polymer may be most preferred. By way of example, one contemplated source of EPDM polymer is recycled weather stripping. Such EPDM may be either of hard or resilient (foam) character. By way of example only, one contemplated source for nitrile rubber is from recycled industrial mats. The rental industrial mat segment is an ideal source of raw material for the rubber crumbs or particles because it ensures that low bleed, low staining nitrile rubber is used as the starting point for the production of the carpet tile. Recycled SBR rubber from recycled tires may also be used if desired. Other rubber materials (solid or foam) may be used. In the event that the particles of the backing structure are foam, recycled EPDM foam or cellular polyurethane foam may be preferred. Resilient materials other than foam may be used. For example, compressible or resilient materials such as cork (which is also a renewable material), hollow particles like hollow spheres, rubber, gel particles, gel filled particles or spheres, and/or the like may be used.

For example, if one uses 100% EPDM particles, then they may need to use up to 10% by weight binder; if one uses a mixture of EPDM particles and cork particles, then they may need to use up to 15% by weight binder; while, if one uses an equal mixture by volume of recycled EPDM particles, cork particles, and recycled carpet tile waste particles, then they may need up to 20% by weight binder to fully cover each particle, bind the particles together, and to bind the particle backing to the carpet and to any secondary backing. In accordance with one preferred example, a particle backing 20 is made up of a mixture of particles of ⅓ cork crumb, ⅓ recycled EPDM rubber crumb, and ⅓ recycled carpet tile crumb based on volume as the densities of these materials varies greatly together with about 5% to about 15% polyurethane MDI binder by weight. Such a particle backing has an aesthetically pleasing appearance due to the mixture of, for example, tan colored cork particles, black colored rubber particles, and brown colored recycled carpet tile particles. Preferably, the binder coats the surfaces of the particles but does not fill all of the voids between the coated particles in the particle backing.

It is contemplated that the size of backing structure particles or crumbs 22, for example, recycled material particles, renewable resource particles, and/or virgin particles, such as recycled foam, carpet, rubber and/or cork particles, utilized preferably range from about 0.01 to about 15 mm, more preferably from about 0.04 mm to about 12 mm, still more preferably from about 0.15 mm to about 10 mm, and yet more preferably from about 0.3 mm to about 8 mm, and most preferably from about 0.5 mm to about 6 mm. For example, if the particle backing is to be about ½ inch thick, then the crumbs should preferably be sized about ¼ inch or less. If the particle backing is to be about ¼ inch thick, the crumbs should preferably be sized about ⅛ inch or less. A low fines crumb may be preferred. However, smaller and/or larger particle sizes may be used if desired. Generally, the size of particle is selected to be as large as possible for the use and properties required.

Even though particles or crumbs of a certain size may be preferred, the particular particle backing may include a majority of particles of the preferred size or range of size but may also include a certain amount of particles below and above the preferred size or range of size. For example, if a screen or mesh is used to filter the particles, then the screen or mesh only sets an upper limit on particle size in one dimension of the particles. For instance, cylindrical particles may have a small diameter but a long length. Also, smaller particles will fit through the mesh or screen. It has been found that particle size can be chosen to give different amounts of resilience, cushion, flexibility, and/or the like in the tile product. Larger particles generally provide greater resilience. Particles of a desired size may be mixed with powder of the same material or a different material to provide a greater tear resistance. Powder may increase the tensile strength for a given binder level. The use of other additives 28 in, for example, powder, fiber, or liquid form may provide the same or different advantages. Suitable additives include, but are not limited to, anti-microbial materials, anti-flammability additives, odorants, colorants or pigments such as iron oxide powder, anti-static additives such as carbon fibers, fillers, such as calcium carbonate, fly ash, sand, used foundry sand, silica, fibers, such as natural or synthetic fibers, for example, glass or Nylon, polymers, plastics, resins, adhesives, carbon black, charcoal, and/or other generally known agents, fillers, additives and/or the like.

Also, one may combine hard and resilient chips, particles or crumbs of the same material or different materials. For example, one may mix foam EPDM particles with solid filler particles and with liquid or powder binder.

The adhesive or binder 24 used to adjoin the particles 22 of backing 20 may be one or more of a variety of binding, bonding, adhering, and the like materials, systems, mixtures, prepolymers, blends, components, and the like. For example, the binder may be a water curing, heat setting or thermoplastic type material. Depending on the process utilized to manufacture the backing, the binder can be, for example, in liquid, fiber, pellet, particle, or powder form. Preferably, the binder is selected from one of the following types: water based adhesives, polyurethane reactive hot melts, copolyester or copolyamide reactive and thermoplastic hot melts, urethane MDI binder, and 4,4-methylene di-p-phenylene isocyanate (4,4′-MDI) polyurethane one- or two-component adhesives. Although not preferred, depending on the precoat 18 and the type of particles or crumbs 22, the binder 24 may be EVA, PVC, SBR, other thermoset adhesives, resins, plastics, polymers, low melts, fibers, particles, pellets, and/or the like which bond or fuse the particles or crumbs 22 to one another.

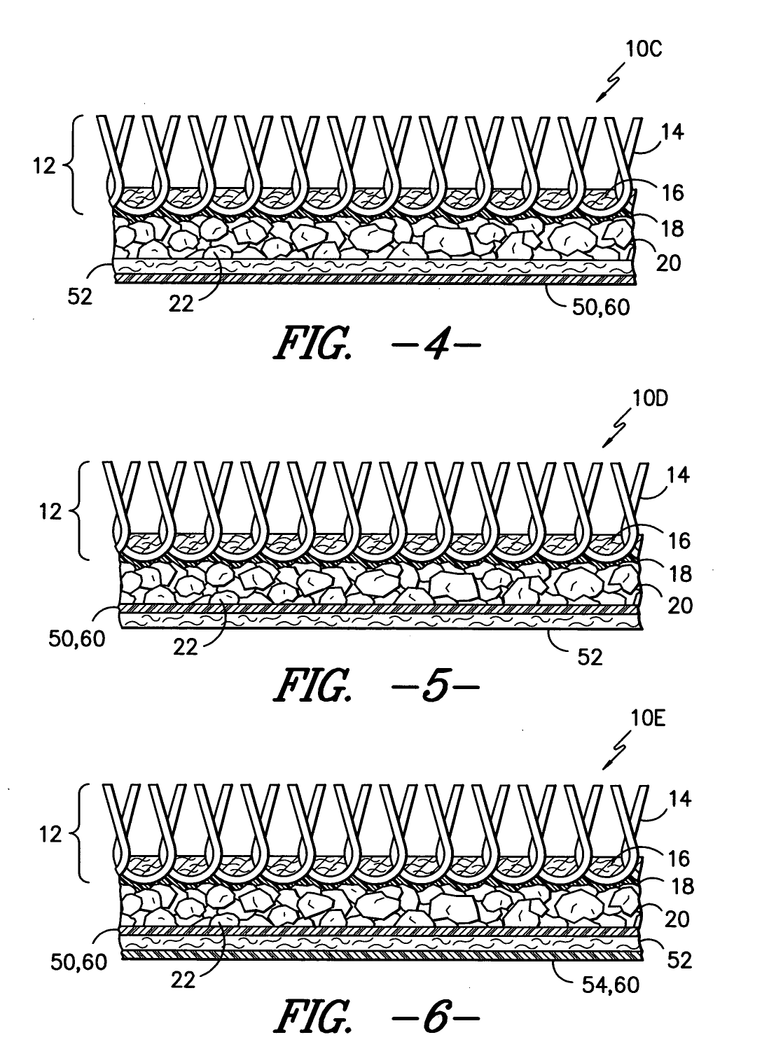

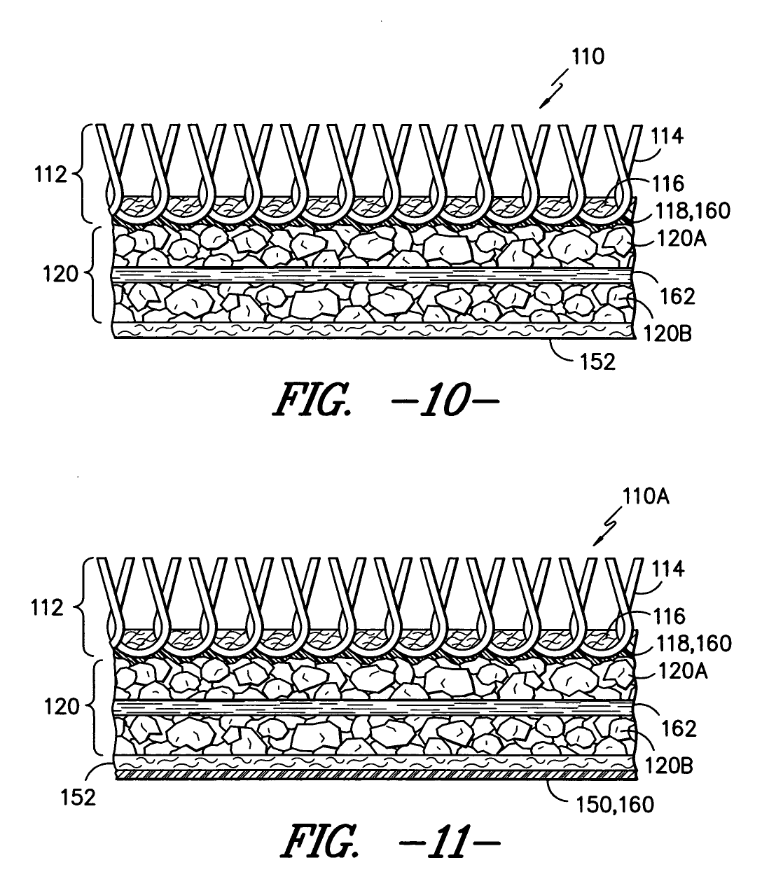

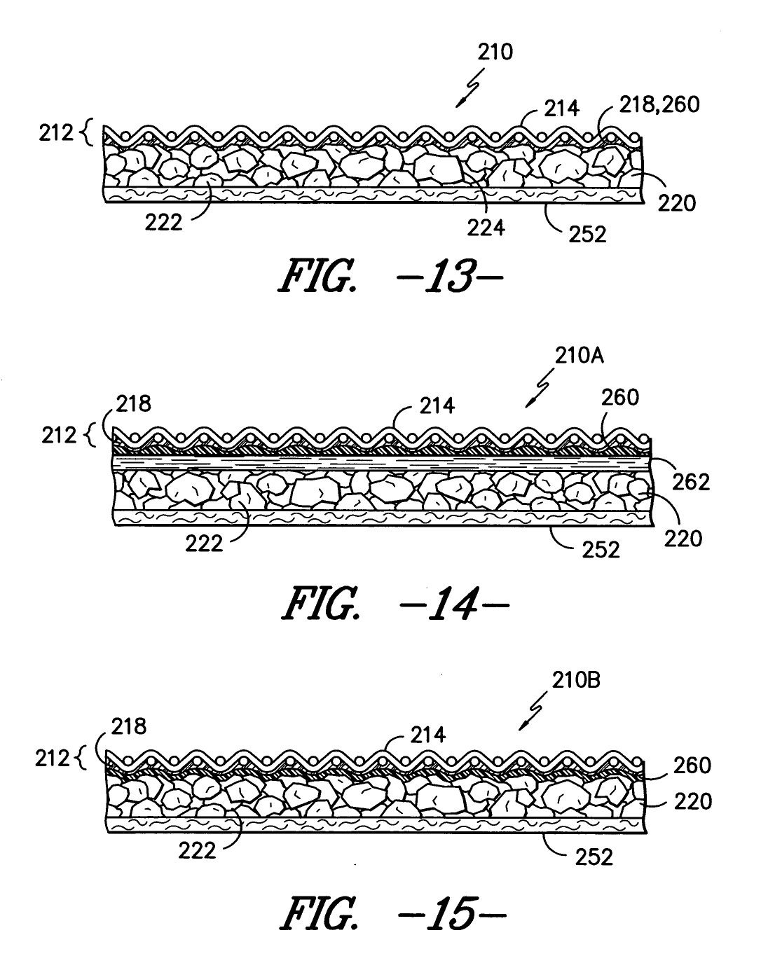

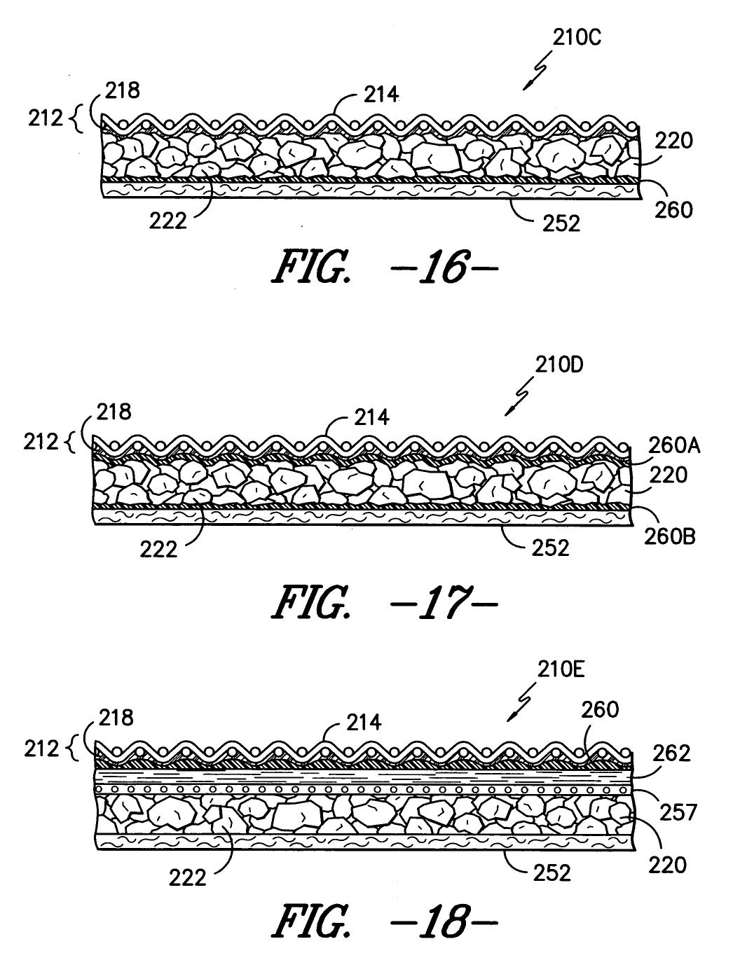

It is preferred that the binder 24 has good adhesive properties to ensure that the particles 22 are well bound, and it may be additionally desirable that sufficient free binder is provided to be capable of forming a physical or chemical bond to the lower exterior surface of carpet 12, precoat 18, tufts 14, or backing 16, to any secondary backings (for example, 50 in FIG. 2, 52 in FIG. 3), to any adhesive or tiecoat layers (for example, 260 in FIG. 15, 264 in FIG. 17), to any stabilizing or reinforcement layers or materials (for example, 162 in FIGS. 10 and 11, 257, 262 in FIG. 18), and the like. The binder should also desirably exhibit sufficient cohesive strength to give the backing 20 sufficient strength. The binder 24 may contain any of the known cross linkers or curing accelerators, water, catalysts, and/or the like to suit the process and the desired properties of the tile product being manufactured and the particles being used. For example, carpet tiles, especially commercial carpet tiles, require dimensional stability and durability, and some flexibility may be desired. Also, one may desire that certain tile products have not only stability and/or flexibility, but also cushion or resiliency (cushion back rather than hardback). If a cushion or resilient (compressible) particle backing is desired, then the binder may be a resilient adhesive, at least some of the particles may be compressible, and voids may be left between particles to allow for the cushion effect. Underfoot comfort may dictate that the carpet tile product be at least slightly compressible under load, but that it not bottom out (fully compress) under typical load (for example, at about 50 psi or less).

In the illustrated exemplary embodiment of FIG. 1, the binder 24 performs the dual function of holding together the particles 22 to form a backing 20 and bonding the backing 20 to the bottom of the carpet 12 (the precoat 18). To perform both functions, binder levels should preferably be in the range of from about 2% to 40% by weight of the particles, more preferably from about 2% to 20% by weight. Use of lower particle sizes or use of particles with high surface area may dictate the use of higher percentages of binder due to greater surface area. In particular, the use of fine powders of size less than 0.5 mm may require about 20% binder by weight or more.

If the crumbs or particles 22 of backing 20 are made from or coated with a material that will bind the particles together during particle backing formation, then addition of binder 24 may not be required. For example, if the particles 22 are recycled waste carpet tile particles including or coated with hot melt adhesive or hot melt adhesive components during particle formation, then the hot melt components of particles 22 may be sufficient to bond the particles 22 together and to carpet 12 (precoat 18). In other words, the particles may be self-binding or the binder may form part of the particles or crumbs 22.

Generally, there is an inverse relationship between the binder content and size of the particles 22 and between the binder content and pressure applied to the binder/particle mixture while forming the backing structure 20. Therefore, as the particle size and the pressure increase, the binder content normally decreases. The binder content also depends on other factors, such as the type of binder, the particle material or materials used, the type of carpet, desired resiliency, and the like, and can be determined by routine experimentation. As binder is usually an expensive material, one would not use more binder than necessary.

For example, the binder may be a liquid polyurethane MDI binder, in which case it is preferably present at a level of from about 2% to 20% by weight, more preferably from about 2% to 12% by weight if, for example, the backing consists primarily of chips or granules. The binder may, for example, contain further additives or materials that are in liquid form and are compatible with the binder, such as water, catalyst, colorants, plasticizers, perfumes, and/or the like. The binder may also contain other additives provided that they are suitable for addition in a liquid medium.

In another example, the binder may alternatively be a thermoplastic or thermosetting powder, such as an adhesive or hot melt powder, in which case it is preferably present at a level from about 2% to 20% by weight, more preferably from about 2% to 12% by weight if the backing consists primarily of chips or granules. A powdered binder may also contain other additives provided that they are suitable for addition in a powder medium.

In accordance with at least selected embodiments, the preferred ranges for binder content may thus be summarized as follows:

Backing of chips/granules: binder content in range from about 2% to 20% by weight, preferably from about 2% to 12% by weight with, for example, an MDI binder or preferably from about 2% to 12% by weight with, for example, a hot melt binder. Backing with 10% powder: binder content in range from about 2% to 40% by weight, preferably from about 9% to 20% by weight.

In certain cases, a binder content of less than about 2% or more than about 40% by weight may be employed. High binder contents may lead to the formation of a skin, reduction or elimination of voids, higher cost, longer set times, slower processing speeds, higher processing temperatures, and/or the like. In accordance with another aspect of the particle/binder backing, a very heavy (dense) particle or crumb material (or materials) may be used with a very light (for example, powder) binder or adhesive. Hence, about 1% or more by volume binder may be sufficient. For instance, a hardback tile product may have a dense particle/binder backing with a low binder content. Conversely, one may use very light particles or crumbs with a relatively heavy binder or adhesive. Hence, the ratio of binder to particles may vary between about 0/100 binder to particles (no binder, self-binding particles) by weight or by volume to about 90/10 ratio of binder to particles by weight or by volume, preferably from about 5/95 to 25/75 ratio of binder to particles by weight.

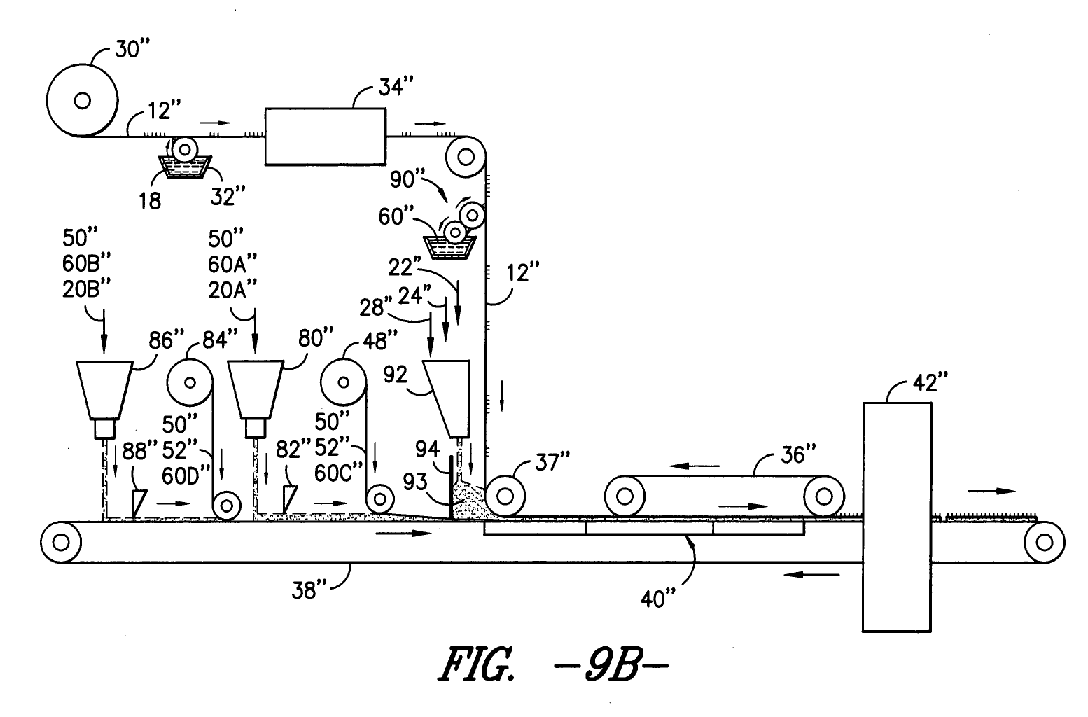

A process for making the carpet tile or modular flooring 10 of FIG. 1 with a backing structure of, for example, granulated particles or crumbs of virgin, recycled, or renewable particles, such as foam, cork, carpet, or rubber particles or crumbs will now be described with reference to FIG. 9, which is a schematic of an integrated processing line and process. In the illustrated process, particles 22 such as a mixture of particles, crumbs, or chips, of, for example, foam, rubber, and/or cork is mixed or blended with a desired binder or binders 24 and any additives or fillers 28 in mixer 44. Note that each of the particles 22 and binders 24 may be premixed or preblended upstream of mixer 44. For example, multiple types of particles 22 may be premixed and fed to mixer 44, water and/or catalyst may be premixed with a urethane binder, the two components of a two-component binder may be premixed upstream of mixer 44, and/or powdered additives 28 may be premixed with particles 22 upstream of mixer 44. Also, a plurality of mixers 44 may be used. The contents of mixer 44 are fed to a deposit head 45 which delivers the binder/particle/additive mixture to a conveyor belt or carrier belt 38 upstream of a doctor blade 46 or other doctoring device. Mixer 44, deposit head 45 and doctor blade 46 form a deposit station that deposits the particles and binder onto the motor driven carrier belt 38. The particle/binder/additive mixture may be deposited directly onto belt 38, onto a release material, layer, film, textile sheet, or the like on belt 38, onto a secondary backing on belt 38, onto a stabilizing or reinforcement layer or material on belt 38, on top of one or more other backings on belt 38, or the like.

To aid in establishing a uniform deposit of particles and binder across the carrier belt 38, the doctor blade 46 or other suitable levelling device is positioned downstream of the deposit station. The doctor blade 46 or other levelling device such as a doctor roll, knife, air knife, or the like may reciprocate, oscillate, have a moving polymer film cover, and/or the like to help set the level of particles on the belt, to flatten and/or compress the particles on the belt, to keep the doctor blade or roller clean (for example, to prevent build-up of particles, binder and/or additives on the blade), and the like.

If the binder 24, particles 22, and additives 28 are all in particle, powder or granular form (rather than liquid form), one may not be as concerned with keeping the blade 46 or roller clean.

It is contemplated that any of a variety of devices may be used to apply binder 24, particles 22, and/or additives 28 to belt 38 and to meter or set the height of the layer of such materials on the belt 38. For example, FIG. 9A shows a preformed particle backing 20′ from a roll 74′ being let down onto belt 38′. FIG. 9B shows a hopper 92 feeding a binder/particle/additive mixture down on to belt 38″ between a wall or stop 94 and a mating roll 37″.

Deposit head 45 of FIG. 9 may be reciprocated back and forth across a selected width of belt 38 in order to deliver a constant supply of particle/binder/additive mixture across the necessary width of belt 38 upstream of doctor blade 46. For example, deposit head 45 may include a screw extruder or feed and a flexible hose, the end of which can be reciprocated back and forth across the belt. Mixer 44 may be a paddle mixer, rotary mixer, or the like.

Doctor blade 46 may doctor the level of the particle/binder/additive mixture to about 1.00 inch, 0.50 inch, 0.25 inch, 0.15 inch, 0.12 inch, 0.10 inch, 0.06 inch, 0.03 inch, or the like. Walls or stops (not shown) running along the length of the belt 38 in the area of doctor blade 46 may serve to keep the particle/binder/additive mixture within set boundaries on the belt.

At set intervals, for example, at the end of each shift, the mixer 44, deposit head 45, other feeds, doctor blade 46, and the like may need to be cleaned to remove any particle, binder, or additive build-up. Water, cleaning agents and/or solvents may need to be used to clean these items depending on the particles, binder, and/or additives in use. Also, when switching from one mixture to another, these items may be cleaned.

The carrier belt 38, like belt 36, is made, for example, of hardened rubber, metal, glass, non-stick polytetrafluoroethylene (PTFE)-coated woven glass fabric, or the like. The belt may be coated with, for example, PTFE, silicone, latex, acrylics, textiles, films, and/or other materials or release agents to prevent the applied materials from sticking to it. In use, the carrier belt 38 advances in the direction of the arrows (clockwise rotation). This movement may be either stepwise or continuous depending upon the nature of the tile product being formed. As illustrated, the carrier belt 38 is disposed in opposing relation to motor driven compression belt 36 which moves in reverse angular relation to the carrier belt 38 to establish a nip zone between the belts in the vicinity of heating and/or cooling elements 40. Materials deposited on the carrier belt 38 thus undergo a degree of compression between the carrier belt 38 and the compression belt 36 while simultaneously being heated or cooled.

In the illustrated process, a precoated or non-precoated (greige goods) carpet material forming at least part of the carpet surface 12 is conveyed from a roll 30 through coater 32 such as a roll coater, reverse roll coater, sprayer, extruder, or the like wherein the precoat or film forming composition 18 is optionally applied to the back of carpet 12. The film-forming composition 18 may be added in one or more steps and is preferably a liquid latex or urethane such as is readily available for precoating the back of greige (grey) goods and the like although acrylics and other suitable tuft lock, tuft bind, adhesives, binders, or compositions may likewise be utilized if desired. By way of example only, and not limitation, suitable precoat compositions are believed to be urethane, polyurethane, latex, nitrile latex, natural latex, diphenylmethane diisocyanate (MDI), polymeric MDI (PMDI), 4,4′-MDI, 2,4′-MDI, 2,2′-MDI, non-isomer-specific MDI, water dispersion urethane precoat system, thermoset adhesive, thermoplastic adhesive, MDI binding adhesive, binder, hot melt adhesive, bitumen hot melt, polyurethane adhesive, urethane reactive hot melt, SBR, EVA, PVC, water based adhesive, and/or the like. It is preferred that the precoat 18 be compatible with and bind to binder 24 of backing 20, especially when there are no adhesive or tiecoat layers between the precoat 18 and binder 24. For example, a urethane precoat and urethane binder, a latex precoat and urethane binder, an EVA precoat and EVA binder, a PVC precoat and PVC binder, an MDI precoat and MDI binder, toluene diisocyanate (TDI) precoat and TDI binder, etc. It is preferred that the precoat, binder, adhesive, tiecoat, secondary coating, and/or the like, be environmentally friendly, environmentally responsible, low VOC, water based, biobased, biodegradable, natural, renewable, recyclable, recycled, moisture cured, non-toxic, ambient temperature cured, nonfugitive, non-volatile, nonreactive, zero risk environment, resilient, elastomeric, formaldehyde free, solvent free, PVC-free, and/or the like if possible or desirable.

After exiting the coater 32, the precoated carpet 12 is then passed through a curing station 34 such as a heater, oven, fan, dryer, other curing equipment, or the like to cure the applied precoat composition to form the lower exterior carpet surface 18 as previously described. The carpet 12 with the cured precoat 18 is then delivered in overlying relation to the particle/binder composition on the carrier belt 38 for subsequent compression and heating and/or cooling between the carrier belt 38 and the compression belt 36. Of course, it is to be understood that the coating or precoating of the carpet or greige goods need not be carried out in the same processing line as the setting (heated compression) of the particle backing 20. In fact, such steps are likely to be carried out in separate processing lines to facilitate processing freedom. Also, the precoat 18 may not be required as shown in FIGS. 7 and 8. Precoat 18 may be replaced with tiecoat or adhesive 60 supplied by roll coater or other coating device 90. If precoat 18 or tiecoat 60 is a hot melt adhesive, then curing station 34 may be a cooling station. Similarly, a pre-heating device such as infrared heaters may be added just upstream of belt 36.

After the precoat layer 18 of carpet 12 or the non-precoated carpet 12 is oriented on top of the particle/binder/additive composition, the pressure and heat (and/or cooling) applied between the opposing belts 36, 38 causes the binder to bond or fuse the particles 22 together thereby forming a stable backing structure 20 of desired thickness and resilience. In this regard, the applied pressure is preferably in the range of from about 0.01 to about 50 pounds per square inch or greater, more preferably from about 1 to 10 pounds per square inch, and the temperature is preferably from about 250 to about 375 degrees Fahrenheit although higher or lower temperatures may be used depending upon the materials of construction and pressure utilized. The heating or cooling platen 40 is preferably divided into a plurality of sections, for example, 40A, 40B, and 40C as shown in FIG. 9. The sections can be heating or cooling sections, such as low heat, high heat, low cool, very low cool, and/or the like. If the binder is a heat set binder (heat sets or accelerates setting of the binder), it is preferred that section 40A be a low heat section, section 40B be a high heat section and that section 40C be a cooling section. If the binder is a cool set (hot melt) binder, it is preferred that section 40A be a high heat section, 40B be a low cool section and section 40C be a very cool section. If all of sections 40A-40C are heating sections, then heating platen 40 and at least a portion of belts 36 and 38 may be located in an oven or steamer. If sections 40A-40C are cooling sections, then cooling platen 40 and at least a portion of belts 36 and 38 may be located in a cooler or chiller.

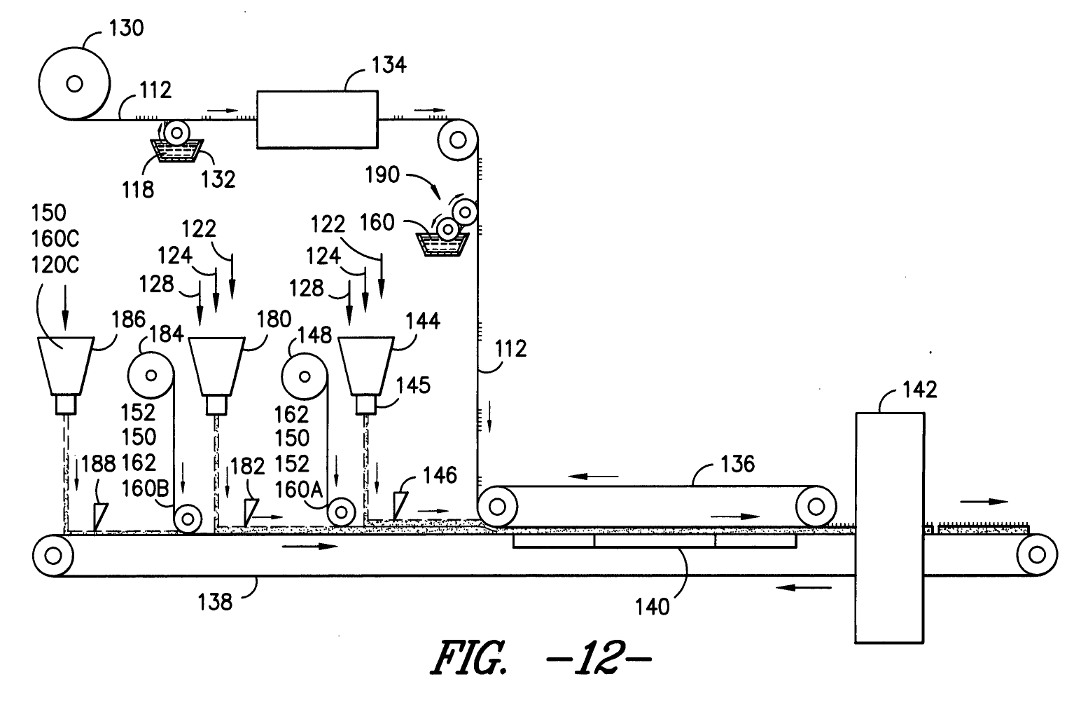

Although only platen 40 is shown in FIGS. 9, 9A and 9B and only platen 140 is shown in FIGS. 12 and 12A, it is contemplated that there may be a plurality of platens below belt 38 and/or above belt 36 to provide the desired heating and/or cooling. Also, the carpet and particle backing construction may be subjected to other heating and cooling means such as infrared (IR), microwave (MW), radio frequency (RF), steam, super heated steam, forced heating, hot fluid, hot air, oven, forced cooling, cold fluid, cold air, cooler, ambient cooling, and/or the like. Further, belts 36 and/or 38 may be heated and/or cooled as desired. Still further, the particle/binder/additive layer may be pre-cured or partially cured upstream of belts 36, 38 using, for example, heating or cooling elements.

The combination of the precoat 18 and the binder 24 in the backing structure 20 may concurrently bond the carpet 12 to the backing structure 20. The layered structure formed has the configuration illustrated in FIG. 1. As will be appreciated, a percentage of the lower surface of carpet 12 may be depressed into and below the surface of the backing structure 20 if desired. After formation, the resultant structure may be delivered to a tile cutter 42 (such as a die cutter) if it is to be used in a modular installation (such as wall-to-wall tile or a modular rug) or accumulated on a roll (not shown) if it is to be cut later.

With reference again to FIGS. 1, 9, 9A, and 9B of the drawings, it is to be understood that in formation or manufacture of the tile product 10 of FIG. 1, that carpet is supplied from roll 30, particle/binder/additive mixture is supplied from mixer 44 and deposit head 45, and that the other feeds or supplies 48, 80, 84, and 86 are not used. Alternatively, if hopper, mixer or supply 80 or 86 is used to supply a belt release agent or composition to the upper surface of the upper run of belt 38 and the belt release agent sticks to the belt 38 and not to particle backing 20, then the resultant product would have the structure as the tile product of FIG. 1.

Likewise, with respect to FIGS. 7, 9, 9A, and 9B of the drawings, coater 32 as well as supplies 48, 80, 84 and 86 are not used or, alternatively, a belt release agent is applied at, for example, supply 80 or 86, to belt 38 (and stays on belt 38, does not become part of tile product 10F).

With respect to FIGS. 2 and 8 of the drawings, tile products 10A and 10G are similar to tile products 10 and 10F, respectively, with the addition of a lower layer, coating, film, release layer, or secondary backing 50 applied to belt 38 upstream of the application of the particle/binder/additive mixture. The lower layer 50 may be, for example, a belt release agent, coating, skin, composition, or the like, such as a latex, acrylic, silicone, or other belt release or mold release agent that sticks to the particle backing 20 and prevents the particle backing 20 from sticking to the belt 38. With reference to FIGS. 1, 8, 9, 9A, and 9B, layer or coating or film or skin 50 may be added to belt 38, 38′, 38″, upstream of the particle/binder/additive mixture by, for example, at least one of supply 48, 80, 84, 86, 48′, 80′, 84′, 86′, 48″, 80″, 84″, 86″ depending on if the coating, layer, film, or the like 50 is a liquid, preformed film, thin film, or the like. For example, a liquid and/or powder coating 50 may be applied to belt 38 by supply, hopper, mixer, or feed 86 and doctored by a doctor blade 88, air knife, or the like. The doctor blade 88 may be covered by a protective polymer film to keep the doctor blade clean. Alternatively, a liquid and/or powder coating 50 may be applied to belt 38 by supply, hopper, mixer, or feed 80 and doctored by a doctor blade, air knife, or the like 82. It is understood that supplies 80 and 86 may also be spray heads or the like depending on the composition, thickness, and the like of coating, film, or layer 50.

If layer 50 is a preformed film, such as a thin polypropylene film, acrylic film, latex film, urethane film, or the like, then preformed film 50 may be added to belt 38 by supply, roll, feed, let off, or the like 48 or 84 upstream of the addition of the particle/binder/additive mixture. A thin polypropylene film such as a black or clear film may be preferred to keep binder 24 from contacting and sticking to belt 38. The carpet 12 tends to keep the binder 24 from contacting the belt 36. Alternatively, layer 50, 54, 60, 150, 160, or the like may be or may be covered by a thin, friction enhancing coating material which may provide enhanced lateral grip and/or vertical stick to the floor or sub-floor. It is contemplated that one or more friction enhancing materials or layers may optionally be added to the bottom of the carpet tiles. Such friction enhancing materials are described, for example, in U.S. patent application Ser. No. 10/209,050 (US Published Application US 2004/0022991) incorporated by reference herein. Preferably, such friction enhancing materials provide additional lateral grip and some vertical stick. Also, backing 20 and/or the other backing layers or materials may include magnetic or magnetizable particles or material to provide a magnetic attraction to, for example, metal raised access flooring. Further, the friction enhancing material may be covered with a releasable, removable, cover sheet to provide a peel-n-stick tile product. The friction enhancing material may be added before, during or after tile product formation.

With reference to FIGS. 3, 9, 9A, 9B, 13, and 20, a secondary backing, release layer, lower textile or fabric layer, 52, 52′, 52″, 252, 452 is added to or laid on belt 38, 38′, 38″ upstream of the particle/binder/additive mixture and bonded to particle backing 20. The secondary backing 52, 52′, 52″, 252, 452, may be, for example, a woven or nonwoven textile such as a woven polypropylene, nonwoven polypropylene, nonwoven polyester, nonwoven polyester/polypropylene, felt, mesh, scrim, mat, glass mat, nonwoven glass, flocked, needled, fabric, natural fiber or yarn, synthetic fiber or yarn, blend of natural and synthetic fibers or yarns, jute, sisal, cotton, and/or the like. It is preferred that layer 52 is a nonwoven textile or felt of polypropylene, polyester and/or acrylic fibers, with at least a portion thereof of recycled fibers, low melt fibers, low melt clad fibers, or the like. In one example, secondary backing or release layer 52 is a blend of polyester and polypropylene fibers ranging from 100% polyester to 100% polypropylene. The backing 52 can be used to balance the face 12 and provide for a flat tile product.

Secondary backing or release layer or textile 52 may be added to or laid on belt 38 via supply, feed, let off, or roll 48, 84, 48′, 84′, 48″, 84″ of FIGS. 9, 9A of 9B upstream of addition of the particle/binder/additive mixture. Backing 52 is bound to particle backing 20 by, for example, binder 24, binder or adhesive in layer 52, low melt or fuse fibers in layer 52, and/or the like

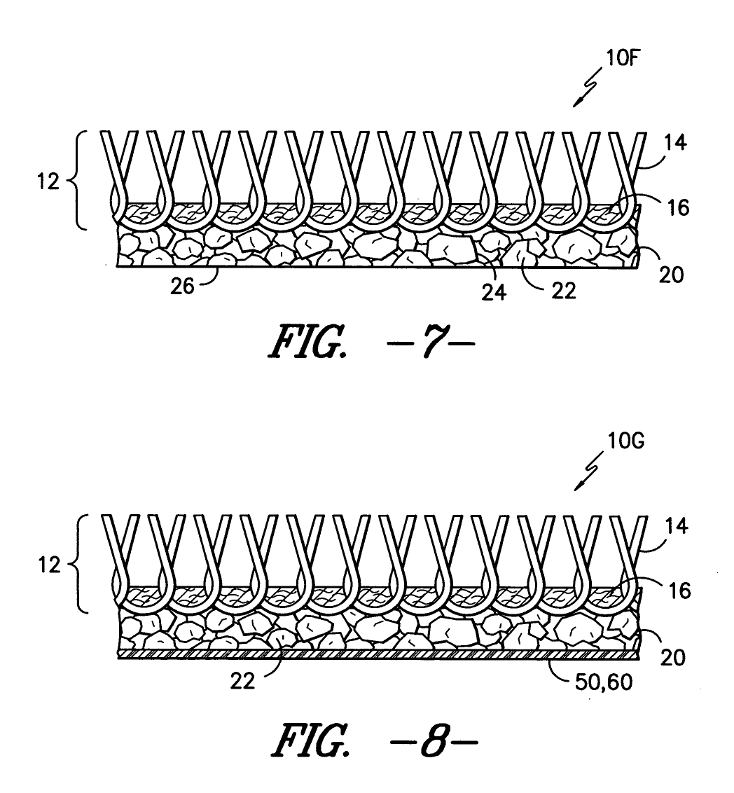

Like layer 52 of tile product 10B of FIG. 3, layer 52 of tile product 10C of FIG. 4 may be added to or laid on layer 50 on belt 38 by supply 48 or 84 and similar to layer 50 of tile product 10A of FIG. 2, layer 50 of tile product 10C of FIG. 4 may be added to belt 38 by supply 80, 84 or 86. If layer 50 of tile product 10C is added by supply 80, then layer 52 of tile product 10C is added by supply 48.

Layer 50 is bound, bonded, attached, or adhered to layer 52 of tile product 10C of FIG. 4 by, for example, binder 24 which passes through layer or fabric 52, the material of layer 50 adhering to layer 52, binder, low melt, or fuse materials in layer 52, and/or the like. Also, layers 50 and 52 may be preformed as a composite and supplied via roll 48 or 84.

Like layer 50 of FIG. 2 and layer 52 of FIG. 3, layer 50 of tile product 10D of FIG. 5 may be added or laid on to layer 52 by, for example, supply 48 or 80 and layer 52 of tile product 10D of FIG. 5 may be added to or laid on belt 38 by supply or roll 84. Also, if layers 50 and 52 of tile product 10D are a preformed composite, then the composite can be added to or laid on belt 38 via supply or roll 48 or 84.

Layer or backing 52 of tile product 10D of FIG. 5 is bonded, bound, adhered, attached, or the like to the particle backing 20 via layer 50. Layer 52 of FIG. 5 is bonded to layer 50 by the material or composition of layer 50, binder, low melt or fuse materials in layer 52, or the like. If, for example, layer 50 of FIG. 5 is a hot melt material, then the heat supplied by platen 40 may melt or soften layer 50 so that it binds to layer 52.

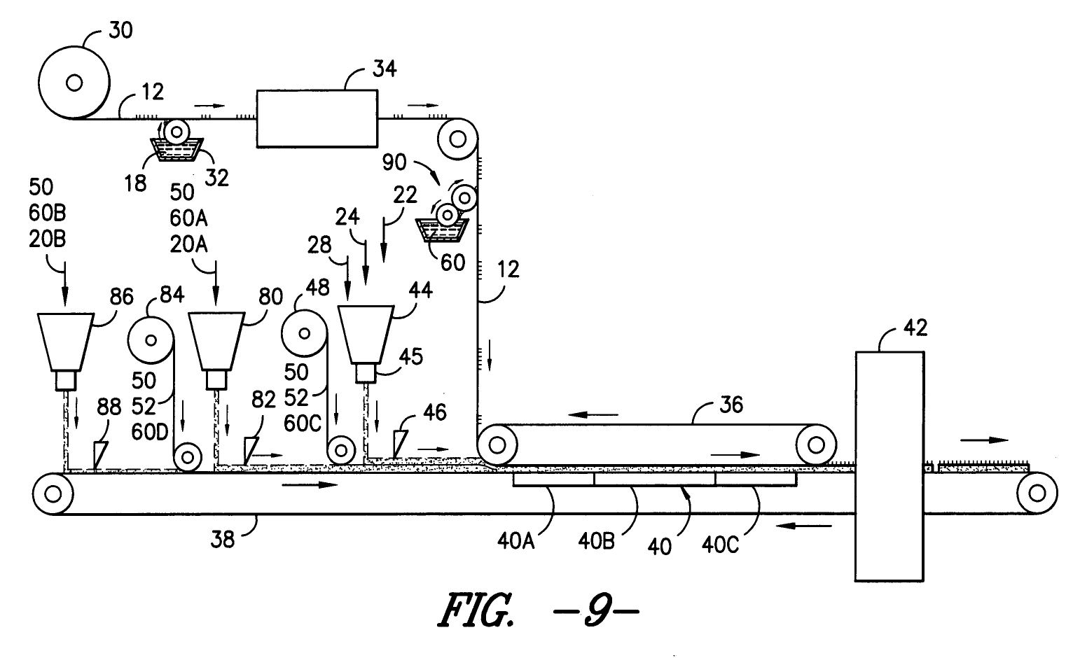

With reference to FIG. 6 of the drawings, the release layer, coating, material, film, skin, or the like 54 is supplied to belt 38 upstream of the layer 52 by supply, feed, or the like 86. The layer 52 is added over or laid on layer 54 by supply or roll 84. The coating, layer, film, or the like 50 of FIG. 6 is added to or laid on layer 52 by supply, roll, feed, or the like 48 or 80. Also, layers 52, 54; 50, 52; or 50, 52, 54 may be a preformed composite and supplied over belt 38 by supply or roll 48 or 84. Layer 54 of tile product 10E, like layer 50 of tile product 10C is bonded, bound, adhered, or attached to layer 52 by the material of layer 54, binder, low melt, fuse, or the like materials in layer 52, material of layer 50 that passes through layer 52, and/or the like.

Layers, coating, backings, or the like 50, 150, of FIGS. 2, 4, 8, and 11, and layer, coating, backing, or the like 54 of FIG. 6, may be a friction enhancing, releasable adhesive, or adhesive material such as TractionBack friction enhancing coating by Milliken & Company of LaGrange, Ga., U.S.A. Such a friction enhancing coating 50, 150, 54, preferably provides for lateral grip but limited vertical stick and is described, for example, in U.S. Published Applications 2003/0072911, 2004/0022991, 2003/0203152, and 2004/0022985 each of which are hereby incorporated by reference herein.

With reference again to FIGS. 7 and 8 of the drawings, tile products 10F and 10G do not include a separate precoat layer, but instead rely upon the binder 24 of backing 20 to serve as the precoat and the adhesive or binder for joining the carpet 12 to the particle backing 20. An especially high addition of binder 24, gravity, high pressure in the double belt laminator (36, 38, 40), and/or the like can produce a thick skin 26 of binder 24 on the bottom of particle backing 20.

Certain enhanced tufting substrates or primary backings 16 such as described, for example, in U.S. Pat. No. 6,866,912, hereby incorporated by reference herein, can reduce or eliminate the need for a precoat or tuft lock layer. If desired, a very thin primer material or layer can be added to the base of carpet 12 (at coater 32 or 90) to enhance the bond between carpet 12 and backing 20.

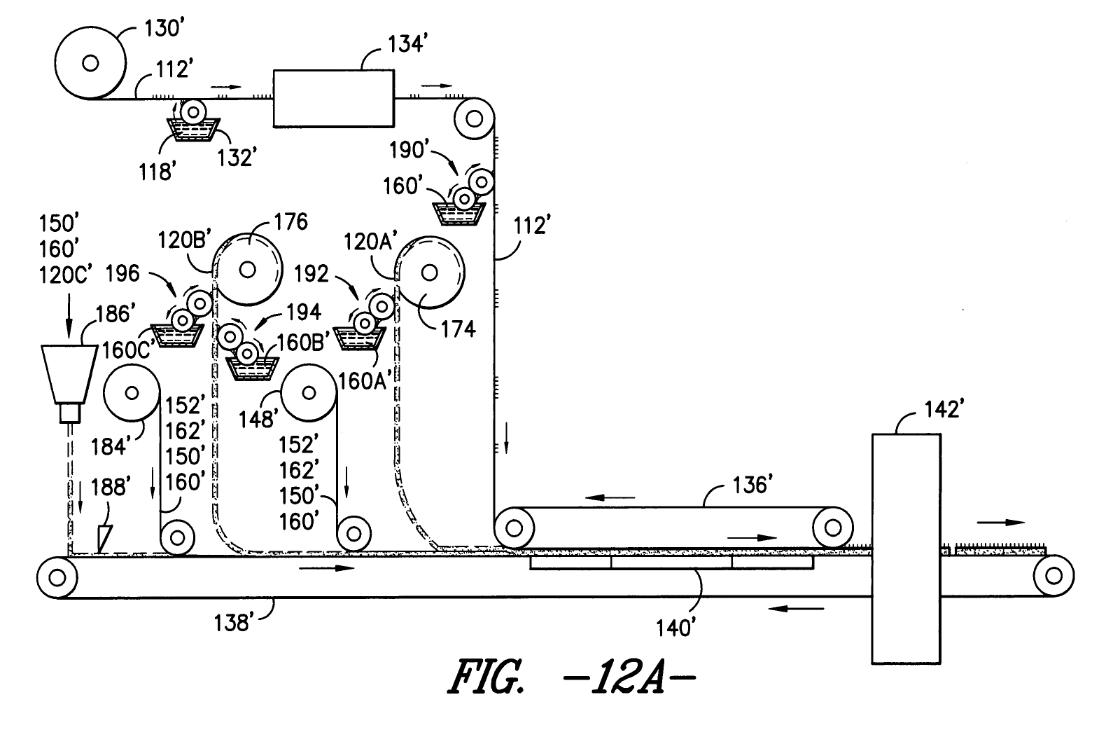

Although FIGS. 1-8, 10-11, and 25 schematically illustrate a tufted, level, cut pile carpet tile construction, it is to be understood that the carpet 12 of the present invention is not limited to level, cut pile, tufted substrates. For example, the present invention encompasses not only level cut pile carpets, but also multi-level cut pile, textured cut pile, loop pile, cut and loop pile, multi-level loop, multi-level cut and loop, needled, needle punched, woven (FIGS. 13-19), bonded (FIG. 20), nonwoven, knit, plush, nap, textured nap, textured loop, treated loop, non-pile, and/or the like.

Of course, if desired, an additional layer of adhesive such as a thermoset or thermoplastic resilient adhesive, for example, a thermoset urethane, a hot melt urethane, polyester, polyamide, or the like may be added at the intersection between the particle/binder backing 20 and the lower surface or precoat 18 of carpet 12. Such an adhesive 60 may further stabilize the structure and provide enhanced protection against delamination. For example, an adhesive or tiecoat layer 60, such as a urethane hot melt, reactive urethane hot melt, thermoset urethane, or the like, may be added in place of precoat 18, between precoat 18 and particle backing 20 (FIG. 15), between particle backing 20 and a secondary backing (FIGS. 5 and 16), below a secondary backing 52 (FIGS. 6 and 11), and/or the like.

With reference to FIG. 9, adhesive or tiecoat material or layer 60 can be added at applicator 90, thin film adhesive 60C can be added at supply roll 48, adhesive 60A can be added at supply 80, thin film adhesive 60D can be added at supply roll 84, and adhesive 60B can be added at supply 86. Adhesive 60A and 60B can be doctored by doctor blades 82 and 88, respectively. If used, such an adhesive layer 60, 160, 260, 264 may be applied in line such as on the bottom of the carpet or greige goods 12 or precoat 18 using coating techniques such as roll coaters or the like. Alternatively, it may also be applied to the top of the backing structure 20 if desired.

Aside from fused chips, particles or crumbs, such as rubber and foam with binder, preferably recycled rubber and/or foam with binder, it is also contemplated that carpet tile of the present invention may incorporate preformed backing structures of, for example, chips, crumbs, binder, and additives, such as, so-called “rebond” or “bonded” foam wherein relatively small chips or pieces of scrap foam are formed into sheets with resilient binder at least between the foam pieces. FIG. 9A illustrates an exemplary processing line for the incorporation of such preformed particle backings, such as, crumb rubber or rebond foam into a layered structure as described in relation to FIG. 1. In FIG. 9A, elements corresponding to those described in relation to FIG. 9 are designated by corresponding reference numerals with a prime.

The process illustrated in FIG. 9A is substantially identical to that described in relation to FIG. 9 with the exception that the deposited mass of particles, binder and additives (if any) is replaced by a roll 74′ of a preformed sheet 20′ of particle backing, for example, particles or crumbs and binder, particles or crumbs, binder and additives, particles and additives, and the like such as rubber, cork, carpet, foam or other particles plus binder and any additives. In order to secure the lower carpet exterior or precoat layer 18′ to this preformed sheet 20′, a coater 90′ is used to apply a layer of adhesive or tiecoat 60′ such as a thermoset or thermoplastic resilient adhesive, such as a hot melt urethane, polyester, polyamide, or the like to the underside of the carpet 12′ prior to mating with the preformed particle backing sheet 20′. Upon entering the nip zone between the opposing belts 36′ and 38′ the pressure and heat applied causes the particle backing to partially compress. The adhesive 60′ and/or any reactive binder between the particles may fuse the particles together in the partially compressed state thereby forming a stable backing structure of desired thickness and resilience. In this regard, greater compression may give rise to reduced levels of cushioning resilience. The carpet 12′ is concurrently bonded to the backing structure 20′ by the intermediate adhesive layer 60′, any reactive binder in backing 20′, heat, pressure, moisture, and the like. After formation, the resultant structure may be delivered to a tile cutter 42′ if it is to be made into carpet tile adapted to be used in a modular installation or accumulated on a roll (not shown) if it is to be cut later.

As with respect to FIGS. 9 and 9A, it is to be understood that any of devices, supplies, coaters, doctoring devices, and/or the like, for example, 32′, 34′, 90′, 48′, 80′, 84′, 86′, or the like may or may not be used in the production of particular tile products such as shown, for example, in any of FIGS. 1-8, 10, 11, and 13-25 and variations thereof preferably incorporating a carpet face and a particular backing or particle backing layer plus any additional layers, elements, skins, coatings, or the like.

An alternative exemplary process for use in forming the illustrated and described tile structures is shown in FIG. 9B. In FIG. 9B, elements corresponding to those described in relation to FIG. 9 are designated by corresponding reference numerals with a double prime. In this process, the particle/binder/additive composition 22″, 24″, 28″ is delivered onto the carrier belt 38″ from deposit station 92″ to form a build-up or puddle 93 of the particle/binder/additive composition between a wall, stop, or dam 94 and the nip between a doctor or compression roll 37″ and the carrier belt 38″. The compression roll 37″ presses the bottom of the carpet 12″ into the particle/binder/additive mass while simultaneously controlling the thickness of the overall construction. During this compression, the underlying portion of heating or cooling elements 40″ raises or lowers the temperature of the layers to initiate bonding. The formed structure thereafter passes between the carrier belt 38″ and a downstream compression belt 36″ to complete joinder. After formation, the resultant structure or composite (tile precursor) may be delivered to a tile cutter 42″ to produce carpet tiles adapted to be used in a modular installation or accumulated on a roll (not shown) if it is to be cut later.

As with respect to FIGS. 9 and 9A, it is to be understood that any of devices, supplies, coaters, doctoring devices, and/or the like, for example, 32″, 34″, 90″, 48″, 80″, 84″, 86″, or the like may or may not be used in the production of a particular tile product such as shown, for example, in any of FIGS. 1-8, 10, 11, and 13-25 and variations thereof preferably incorporating a carpet face and a particular backing or particle backing layer plus any additional layers, elements, skins, coatings, or the like.

The present invention is also readily adaptable to tile structures requiring substantial levels of internal dimensional stability such as, for example, free lay carpet tile, cushion back carpet tile, tile blanks to be dyed, and the like. One exemplary structure for a carpet tile 110 intended to have such internal dimensional stability is illustrated in FIG. 10 wherein elements corresponding to those in earlier figures such as FIGS. 1-6 are designated by corresponding reference numerals increased by 100. As shown, in the embodiment of FIG. 10, the carpet tile 110 such as a free-lay carpet tile or the like incorporates a multi-layer stabilized backing structure 120 having a stabilizing or reinforcement layer 162 such as a woven or non-woven textile or material, for example, a non woven glass mat disposed between opposing particle backing layers 120A, 120B of virgin, renewable, recycled, or recyclable particles, such as cork, foam, carpet or rubber particles held together with one or more binders and including any additives as previously described. In addition, one or more layers of adhesive 160 such as a hot melt urethane, polyester, polyamide or the like may be disposed, for example, between the carpet 112 and the upper surface of the backing structure 120. If desired, an optional backing such as sheet 152 of woven or non-woven construction and/or other coating, skins, films, may be placed across the underside of particle backing 120 either with or without an intermediate adhesive layer.

An exemplary process for making the carpet tile 110 of FIG. 10 with a backing structure incorporating particle backing layers of, for example, granulated particles of cork, carpet and/or rubber, preferably recycled cork, carpet tile, and/or rubber, will now be described with reference to FIG. 12, which is a schematic of an integrated exemplary processing line. In one embodiment of the illustrated process, a backing sheet 152 of, for example, a textile fabric, film or the like, such as a woven or non-woven textile material is delivered from roll 184 in overlying relation to a carrier belt 138. By way of example only, the backing sheet 152 is preferably a non-woven felt material incorporating polyester and/or polypropylene fibers in any desired ratio between 100% polyester to 100% polypropylene and may include acrylic fibers as well. At a downstream location, a mixture of foam, rubber and/or cork particles in blended relation with a desired binder is delivered from a first deposit station including a mixer 180 that blends the particles 122, binder 124, and any additives 128 and deposits them onto the backing sheet 152. To aid in establishing a uniform deposit of particles and binder across the backing sheet 152 a doctor blade 182 or other suitable levelling device is positioned downstream of the first deposit station. A layer of stabilizing material 162 such as woven or non-woven glass is thereafter applied from roll 148 in juxtaposed relation across the particle and binder layer. Once the stabilizing layer 162 is in place, a second mixture of particles, binder and additives in blended relation with a desired binder is delivered from a mixer 144 onto the stabilizing layer 162 from a second deposit station that blends the particles and binder and includes a deposit head 145. To aid in establishing a uniform deposit of particles and binder a doctor blade 146 or other suitable levelling device is positioned downstream of the second deposit station.

The carrier belt 138, like belt 136, is made, for example, of PTFE-coated woven glass fabric to prevent the applied materials from sticking to it. In use, the carrier belt 138 advances in the direction of the arrows (clockwise as shown). This movement may be either stepwise or continuous depending upon the nature of the tile product being formed. The carrier belt 138 may have a smooth or textured outer surface. A textured surface of the belt 138 may impart a texture to the base of tile product 110. As illustrated, the carrier belt 138 is disposed in opposing relation to motor driven compression belt 136 which moves in reverse angular relation to the carrier belt (counter clockwise as shown) to establish a nip zone between the belts in the vicinity of heating and/or cooling elements 140. Materials deposited on the carrier belt 138 thus undergo a degree of compression between the carrier belt 138 and the compression belt 136 while simultaneously being heated and/or cooled.

In the illustrated process of FIG. 12, a carpet or carpet fabric 112 is conveyed from a roll 130 to a first coater 132 such as a roll coater or the like wherein the precoat or film forming composition 118 is applied in saturating relation to the bottom of the carpet 112. The precoat composition 118 is preferably a liquid latex or urethane precoat material, binder, primer, or the like although acrylics and other suitable compositions such as SBR, EVA, PVC, or blends may likewise be utilized if desired. After exiting the coater 132, the coated carpet fabric is then passed through a curing station 134 such as a heater, cooler, dryer, or the like to cure the applied composition 118 thereby forming the lower exterior of carpet 112. The precoated carpet 112 may then be delivered to a second coater 160 such as a reverse roll coater or the like for application of the adhesive or tiecoat layer 160 to the underside surface of carpet 112. The carpet with the cured coating 118 and applied adhesive 160 is then applied in overlying relation to the upper layer of particle/binder composition for subsequent compression and heating and/or cooling between the carrier belt 138 and the compression belt 136. Of course, it is to be understood that the coating of the carpet fabric need not be carried out in the same processing line as the heated compression. In fact, such steps are likely to be carried out in separate processing lines to facilitate processing freedom. Hence, the carpet with or without precoat 118 and/or adhesive 160 may be supplied in roll form.

After the carpet 112 is oriented on top of the particle/binder/additive composition, the pressure, heat, cold, moisture, and/or the like applied between the opposing belts causes the binder to bond or fuse the particles together thereby forming a stable backing structure 120 adhered to both sides of the stabilizing layer 162 and to the carpet 112. In this regard the applied pressure is preferably in the range of from about 0.01 to about 50 pounds per square inch, preferably from about 0.1 to about 20 pounds per square inch, and most preferably between about 2 to about 8 pounds per square inch to avoid excess pressure, pile crush, etc. and the temperature is preferably in the range of from about 200 to 500 degrees Farenheit, more preferably, about 250 to 375 degrees Fahrenheit. The stabilized composite 120 is concurrently bonded to the carpet 112 and the backing 152, 150, 160 by the binder in combination with any applied adhesive. After formation, the resultant composite structure or construction may be delivered to a tile cutter 142 or accumulated on a roll (not shown) if it is to be cut later.

The indexing or continuous movement of belts 136, 138, depends on factors including the tile product to be produced, the amount of compression required, the speed of setting or curing of the binder, additives, adhesives, precoats, films, coatings, and/or the like. For example, a section or increment of tile product composite can sit between belts 136, 138 under pressure and heat for, for example, anywhere from about 1 to 60 minutes, preferably 2 to 30 minutes, more preferably less than 5 minutes. The time to set or cure can be reduced by, for example, adding water and/or other catalyst or accelerators to the binder, particle/binder/additive mix, particle/binder mix, particles, additives, and/or the like. For example, one may add a small quantity of water and/or catalyst to an MDI binder to speed up the set time from about 20 minutes to about 10 minutes. Also, increases in pressure, temperature can reduce set time.

Even though belts 136, 138 can be driven in increments or steps, it is preferred that they are run continuously for an in-line, continuous operation. For example, belts 136, 138 may form part of a continuous double belt laminator system and may be run, for example, at 10 feet per minute, 20 feet per minute, 40 feet per minute, or the like. It may be preferred that the carpet face particle backing composite have an overall dwell time, for example, under heat and pressure of between about 1 to 20 minutes, more preferred 2 to 10 minutes, most preferred about 3 to 8 minutes.

Also, it may be preferred that the tile product 110 include a lower or bottom coating, film, layer, and/or the like such as 150, 160, or 120C. It may be most preferred that tile product 110 have a lower coating of a friction enhancing composition.

Aside from in-line formed particle backings of, for example, virgin, recycled, renewable, or recyclable particles such as cork, carpet, carpet tile, rubber and foam, it is also contemplated that carpet tiles of the present invention may incorporate preformed particle backing structures of such virgin, renewable, recyclable, recycled, natural, synthetic, and/or the like particles, for example, preformed particle/binder/additive backings or backing layers, such as so-called “rebond” or “bonded” foam, such as rebond polyurethane foam, wherein relatively small pieces of scrap foam are formed into sheets with resilient binder between the foam pieces. FIG. 12A illustrates an exemplary processing line for the incorporation of such preformed particle backing such as crumb rubber, rebond foam or other bonded particles into a layered structure as described in relation to, for example, FIGS. 10 and 11. In FIG. 12A elements corresponding to those described in relation to FIGS. 10, 11 and 12 are designated by corresponding reference numerals with a prime. The exemplary process illustrated in FIG. 12A is substantially identical to that described in relation to FIG. 12 with the exception that the deposited layers of particles and binder 120A, 120B are replaced by preformed sheets 120A′, 120B′ of preformed particle backing, such as rebond foam. In the illustrated process, layers of adhesive 160′ such as thermoset or thermoplastic adhesive, such as hot melt urethane adhesive or the like are applied between each of the preformed sheets 120A′, 120B′ of bonded particles and the adjacent layers by coaters 190′, 192′, 194′, 196′ to facilitate bonding. Upon entering the nip zone between the opposing belts 136′, 138′ the pressure and heat applied causes the bonded particle layers to partially compress. The adhesive and/or binder between the particles may fuse the particles together in the partially compressed state thereby forming a stable backing structure of desired thickness and resilience. In this regard, greater compression may give rise to reduced levels of cushioning resilience. The bottom of carpet 112′ is concurrently bonded to the backing structure 120A′ by the adhesive 160′ and/or binder of the preformed particle backing sheet in combination with the applied adhesive 160′. After formation, the resultant structure may be delivered to a tile cutter 142′ or accumulated on a roll (not shown) if it is to be cut later.

As with respect to FIGS. 9, 9A, 9B it is to be understood that any of devices, supplies, coaters, doctoring devices, and/or the like 132, 132′, 134, 134′, 190, 190′, 148, 148′, 176, 180, 184, 184′, 186, and/or 186′, of FIG. 12 or 12A, or the like may or may not be used in the production of particular tile products such as shown, for example, in any of FIGS. 1-8, 10, 11, and 13-25 and variations thereof preferably incorporating a carpet face and a particle backing or one or more particle backing layers plus any additional layers, elements, skins, coatings, or the like.

For example, with reference to FIGS. 11 and 12A of the drawings, the tile product 110A of FIG. 11 may if desired include one or more additional adhesive layers, for example, adhesive layer 160, 160′ between precoat 118 and particle backing 120A, adhesive layer 160A, 160A′ between particle backing 120A and stabilizing layer 162, adhesive layer 160B, 160B′ between stabilizing layer 162 and particle backing layer 120B, and adhesive layer 160C, 160C′ between particle backing layer 120B and backing material 152.

Of course it is to be understood that any number or other embodiments may be utilized for the carpet tiles or modular flooring of the present invention depending upon contemplated use and performance requirements. By way of example only, one contemplated alternative construction is illustrated in FIGS. 13-18 which show a woven carpet construction and in which elements corresponding to those previously described are designated by like reference numerals within a 200 series. As will be appreciated, the carpet tile 210 in FIG. 13 is of substantially the same construction as described in relation to FIG. 3 but with a woven carpet face 212 including yarns 214 and a precoat 218. In FIG. 13, a backing sheet 252 is preferably held in place by binder 224 securing particles 222 together in the particle backing layer 220. However, an additional adhesive layer 260 may be used if desired. It is contemplated that such a structure may be formed by a process as illustrated and described in relation to FIG. 9 if the backing structure 220 is of a particle/binder/additive mixture, FIG. 9A if it is a preformed particle backing or FIG. 9B as an alternative process. With reference to FIG. 9, tile product 210 may be produced on the same range or process line by merely replacing tufted carpet 12 with woven carpet 212. Also, one need not use feeds or supplies 80, 84, 86, and 90 to make tile product 210.

With reference to FIGS. 14 and 9, tile product 210A can be made on the range or process line of FIG. 9 using feeds or supplies 30, 32, 90, 48, 80 and 84.

With reference to FIGS. 15 and 9, tile product 210B can be made on the range or process line of FIG. 9 using feeds or supplies 30, 32, 90, 44, 45, and 48.

With reference to FIGS. 16 and 9, tile product 210C can be made on the range or product line of FIG. 9 using feeds or supplies 30, 32, 44, 45, 80, and 84.

With reference to FIGS. 17 and 9, tile product 210D can be made on the range or process line of FIG. 9 using feed or supplies 30, 32, 90, 44, 45, 80, and 84.

With reference to FIGS. 18 and 9, tile product 210E can be made on the equipment of FIG. 9 using feeds or supplies 30, 32, 90, 48, 80, and 84 if both layers 262 and 257 are let off of roll 48. Alternatively, another roll or let off for layer 257 could be add between roll 48 and feed 80.

With reference again to FIG. 14, a stabilizing layer 262 such as woven or nonwoven glass mat or scrim or the like is adhesively bonded below the carpet material 212 by a layer of adhesive 260 such as a hot melt urethane or the like. The resulting structure provides substantial internal dimensional stability and may be particularly suitable for articles such as free-lay carpet tile and the like.

With reference again to FIG. 15, a particle/binder layer 220 is adhesively bonded below the carpet 212 by a layer of adhesive 260 or such as a hot melt urethane or the like.

With reference to FIGS. 13-20 and 25 of the drawings, it is contemplated that the secondary backing 52, 252, 352, 452 may include additional layers, coatings, skins, films, and/or the like. For example, a friction enhancing coating 50 or 60 may be added below textile or material 52. For instance, a TractionBack friction enhancing coating by Milliken & Company of Spartanburg, S.C., U.S.A., may be added. Alternatively, the secondary backing may include a release material, release film, release sheet, or the like.

With reference again to FIG. 16, this tile construction is a modification of that in FIGS. 13 and 15 wherein the adhesive layer 260 is positioned between the backing structure 220 and a fibrous backing sheet 252. Adhesive layer 260 may be helpful in bonding backing 220 to, for example, a polyester or polypropylene nonwoven or felt backing 252.

With reference again to FIG. 17, this tile construction is a modification of that in FIGS. 13, 15, and 16 wherein an adhesive layer 260A is disposed between carpet 212 and particle backing layer 220 and another adhesive layer 260B is disposed between the backing structure 220 and a fibrous backing sheet 252.

With reference again to FIG. 18, this tile construction is a modification of that in FIG. 14 wherein a scrim layer 257 such as a glass, polyester, polypropylene and/or the like woven or nonwoven mesh or net-like material is disposed adjacent to the stabilizing layer 262 such as a nonwoven glass mat. The resulting tile structure provides substantial internal dimensional stability and may be particularly suitable for articles such as free-lay commercial carpet tile and the like. For example, the scrim 257 may balance any shrinkage in the face material 212 or backing 252 to provide for a flat or slightly domed tile product. The additional stabilizing layer or scrim 257 may facilitate the removal of textile backing 252, use of a lighter face fabric 214, use of less composition 218 or 260, the provision of a more durable, printable tile product, and/or the like.

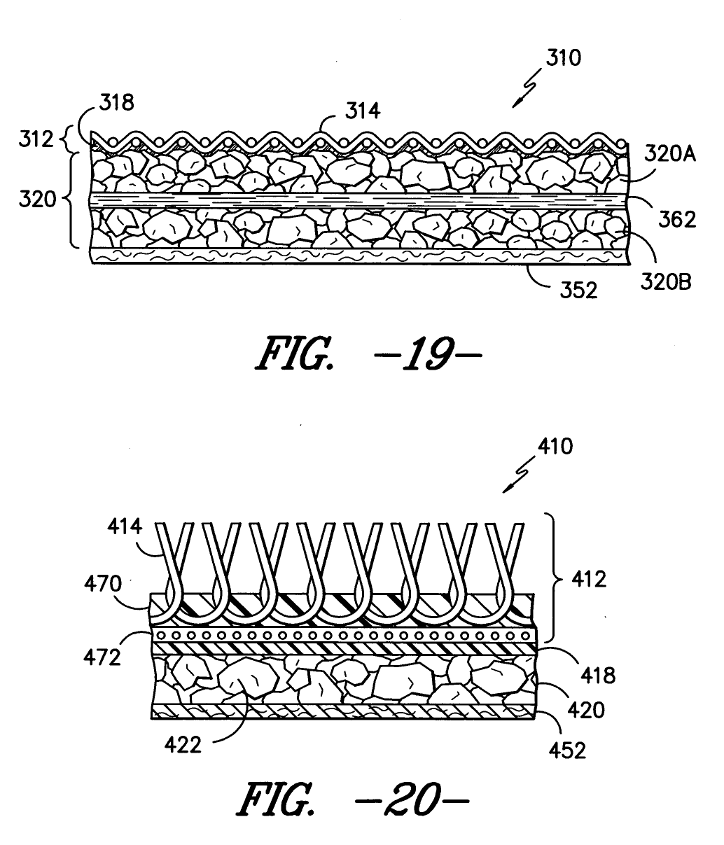

Another contemplated tile construction is illustrated in FIG. 19 wherein elements corresponding to those previously described are designated by like reference numerals within a 300 series. As will be appreciated, this tile construction is a modification of that in FIG. 13 wherein no additional adhesive is disposed between the precoat 318 and underlying layers. It is contemplated that such a structure may be formed by a process as illustrated and described in relation to any of FIGS. 9, 9A, 9B, 12, 12A. For example, tile product 310 can be made on the range of FIG. 12 using feeds or supplies 130, 132, 144, 148, 180, and 184.

Yet another contemplated tile construction is illustrated in FIG. 20 with reference numerals in a 400 series. Tile product 410 of FIG. 20 is like tile product 10B of FIG. 3 and like tile product 210 of FIG. 13 except that it has a bonded carpet face 412 in place of a tufted or woven face. The bonded face 412 includes tufts 414, an adhesive 470, a support substrate 472, and a precoat layer 418. Precoat 418 may be eliminated if desired (like in FIGS. 7 and 8) or if adhesive 470 extends below substrate 472 and is compatible with the binder in particle backing 420. Tile product 410 can be made the same way as tile products 10B and 210.

As will be appreciated, if desired, additional layers of adhesive such as hot melt urethane, polyester and/or polyamide or the like may be added at one or more of the intersections between any of the layers in any of the illustrated embodiments. Thus, by way of example, a layer of adhesive may be added between the backing sheet and the adjacent backing layer and/or between the lower backing layer and the stabilizing layer (if utilized) and/or between the stabilizing layer (if utilized) and the overlying backing layer (if present). Likewise, it is contemplated that in any of the illustrated and/or described embodiments that the structure may be formed with or without a fibrous backing sheet. Also, additional binder may be added to the surface of any layers, sheets, or the like, such as preformed particle sheets such as crumb rubber or rebond foam, or may be used as an adhesive, tiecoat, etc.

One contemplated benefit of the carpet tile constructions of the present invention is the ability to incorporate large percentages of recycled, renewable, recyclable, natural, biodegradable, biobased, environmentally friendly, environmentally responsible, and/or the like materials such as recycled waste products, such as recycled weather stripping, recycled mats, recycled tires, recycled carpet waste, and such as renewable resources such as natural products such as cork or wood, and/or the like. By way of example only, recycled particle or crumb materials such as ground up carpet may be blended with the rubber particles and binder prior to being deposited in the desired layered relation. In such a process the carpet waste may not undergo melting but may rather form a constituent of the resilient matrix forming the backing. Thus, relatively large amounts of carpet waste may be incorporated without negatively impacting resiliency since the individual rubber particles are not melted, voids remain, etc. In one example, the particle binder mixture is made up of one-third cork particles, one-third recycled rubber particles, and one-third recycled surface covering particles. The one-third proportion can be based on either weight or volume. Binder such as MDI binder bonds the three different types of particles together.

Another benefit of the constructions of the present invention is that the tile products of the present invention (and any waste) may be recycled and used as particles or crumbs in the particle backings of the present invention. Thus, for example, the tile products 10, 110, 210, 310, 410 may be ground up and recycled as new backing material.

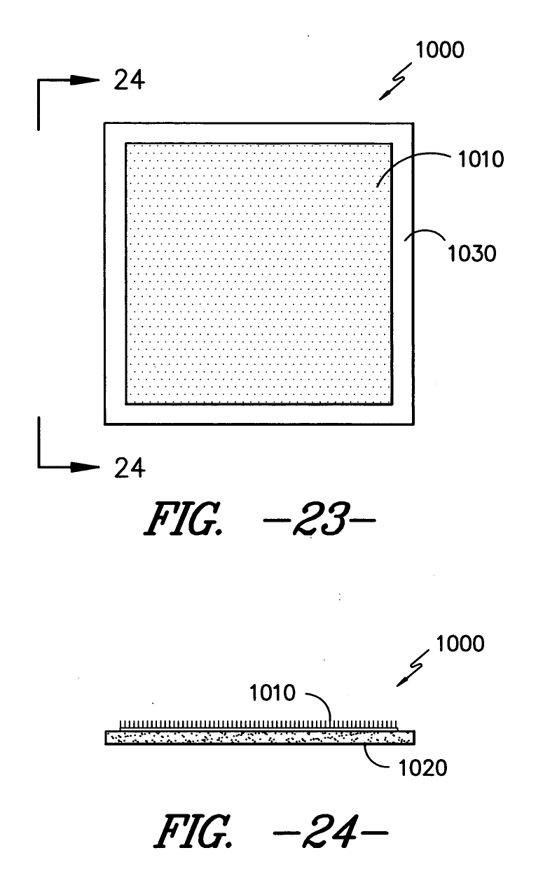

With reference to FIGS. 21 and 22, an exemplary carpet tile product 900 has a decorative show surface 910 defined by an exterior layer such as a pile or nap layer incorporating a decorative appearance, color, shade, pattern, texture, or the like, such as a jet dyed pattern, overlying a particle backing 920. Of course, it is to be understood that while a single layer particle backing 920 has been shown for simplicity, any of the described backing constructions may likewise be used if desired. Likewise, while a square tile is illustrated, it is contemplated that other shapes and geometries, such as rectangular, circular, oval, interlocking dovetails, interlocking chevrons, and/or the like, may also be utilized.

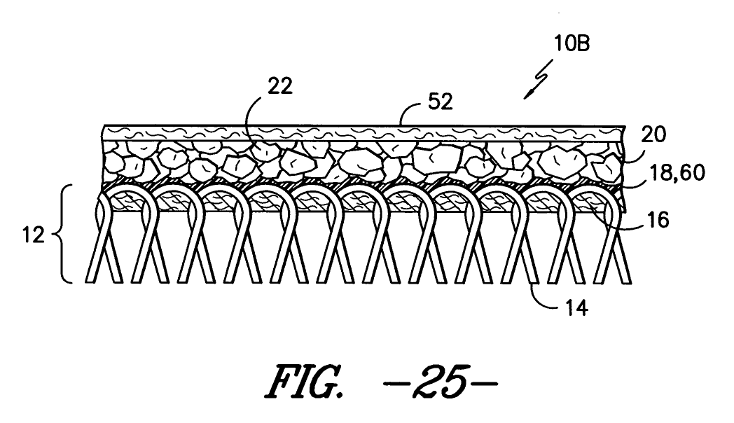

It is also contemplated that the materials forming the backing structures may themselves be used to provide a portion of an aesthetically pleasing tile show surface. By way of example only, in FIGS. 23 and 24, a carpet tile 1000 is illustrated having a decorative show surface 1010 defined by a composite layer such as a pile or nap layer incorporating a decorative appearance, color, shade, pattern, texture, or the like, such as a jet dyed pattern, overlying a particle backing 1020. As shown, a portion of the particle backing 1020 extends outboard or outward of the exterior layer to define a decorative backing border 1030. Such a tile construction may be useful in facilitating the placement of tiles relative to one another across a surface since all edge borders will be of a generally matching appearance. The particle backing 1020 may have a pleasing appearance. For example, a mixture of rubber and cork chips or a mixture of colored particles, such as colored EPDM particles, may look good on their own.

The materials forming the backing structures may also be used to provide a portion of an aesthetically pleasing tile show surface by using show surface fabric constituents of relatively open weave or knit construction (including mesh or net-like scrims) such that the backing is visible through the show surface fabric. Such open fabrics may be used alone or in combination with outboard borders.

The bottom surface of any of the tile structures, constructions, or products of the present invention may also be textured such as by embossing to, for example, enhance surface friction or the like.

In accordance with one possible embodiment of the present invention, the construction of a carpet face and a backing of at least one layer of agglomerated, adjoined particles are cured, cut into floor tile blanks, colored, printed or dyed, then cured, sheared, packaged, shipped, and the like.

It is usually easier to print or dye in register by printing or dyeing tile blanks or modular blanks as contrasted to printing or dyeing in broadloom form. A backed floor tile blank (carpet face, particle/binder backing, with or without an additional stabilizing layer, adhesive layer, textile backing, friction enhancing backing, and/or the like) with a light color or white textile face adapted to be colored, printed, dyed, or the like is adapted to be colored, dyed, printed, textured, treated, embossed, and can have, for example, an image, design or pattern applied thereto with relative precision (for example, by placing a square tile blank in a jig) to produce, for example, a floor tile with an image, pattern, or design which will register with an adjacent image, pattern, or design of an abutting floor tile in a floor tile installation. In this manner, a large image, pattern or design can be split up into a number of parts with each part on a separate tile. Alternatively, a tile pattern that is intended to mate with at least certain elements of an adjacent tile pattern can do so with precision and in registration to provide a very pleasing, seamless, appearance to the overall installation.

Similarly, a tile blank or modular blank with a carpet face of show surface and a particle/binder backing may be cured and then colored, printed, dyed, and/or the like by, for example, a printing process (for example, transfer printing, screen printing, rotary printing, or the like).

Most dyeing and printing is done on white or light colored materials (substrates). Nevertheless, one can also print light colors on a dark face material.

In accordance with at least one embodiment of the present invention, the face and/or backing of the carpet tiles of the present invention meets or exceeds industry standards of, for example, flammability, smoke, toxicity, soil protection, antimicrobial, odour, VOC, smoke density, pill test, lightfastness, crocking, static electricity, dimensional stability, Aachen test, dye fastness, durability, caster chair test, face weight, height, flexibility, size, cup, curl, bow, bias, skew, height variation, dimensional variation, stain protection, soil resistance, stain resistance, cleanability, commercial rating, residential rating, cushion, resilience, drape, seamability, appearance retention, compression, compression set, recycled content, recyclable content, renewable material content, and/or other industry standards, environmental standards, test ratings, and/or the like. For example, floor covering industry standards and/or specifications, more particularly, commercial flooring standards, residential flooring standards, institutional flooring standards (such as hospital, education and/or government standards), hospitality flooring standards, retail flooring standards, tile standards, and/or the like. For example, the carpet tile may be PVC-free.

In accordance with at least one embodiment of the present invention, it is preferred that the particles and/or crumbs in the particle/binder backing structure or layer be about 6 mm or less (powder or granules).

The particle/binder backing of at least one embodiment of the present invention is cured at about 100 psi (pounds per square inch) or less, preferably 50 psi or less, more preferably 25 psi or less, most preferably 10 psi or less. A low pressure cured particle/binder backing having some voids between the crumb (particles) and having, for example, crumb ranging in size mainly from about 2 mm to about 6 mm provides lateral grip with smooth and even carpeted surfaces. This lateral grip provides carpet tiles which tend not to creep or walk. Carpet tiles of the present invention having this lateral grip tend to stay in place after installed even without full spread adhesive installation, releasable adhesive installation, double sticky tape installation, and even free-lay or adhesive free installation.

The particles or crumbs of the particle/binder or particle/binder/additive backing of at least certain embodiments of the present invention may be selected from recycled, recyclable, renewable, waste, by-product, reclaimed, and/or virgin materials.

It is preferred to use recycled, recyclable, and/or renewable materials when possible. For example, recycled flooring, recycled foam, recycled rubber, recycled cork, cork, wood, and combinations thereof, are preferable. Recycled flooring such as recycled carpet, recycled carpet tile, recycled waste carpet, recycled carpet, recycled trim waste, recycled carped production waste, and the like can be processed to produce particles or crumbs of less than about 20 mm, preferably less than about 15 mm, more preferably less than about 10 mm, and most preferably less than about 6 mm (powder or granules). Although post consumer recycled content may be preferred, post industrial recycled content, renewable material, recyclable material, bio-based, biodegradable, and other environmental friendly or environmentally responsible materials may be used.

With reference to FIG. 25 of the drawings, the tile constructions of the present invention may be made, processed, manufactured, or the like inverted or upside down to facilitate or simplify construction. With reference to FIGS. 3, 9 and 25, the tile product 10B may be made on the range or process line of FIG. 9 (on a double belt laminator) by precoating the carpet, inverting the carpet (so that is tufts down as shown in FIG. 25), placing the inverted carpet on the belt 38 (near the left-hand end of the belt 38), adding the particle/binder/additive mixture on the inverted carpet, doctoring the particle/binder/additive mixture, placing the backing material 52 on top of the doctored particle mixture, then feeding the composite through belts 36, 38 to set or cure the binder and laminate the carpet 12 and backing material 52 to the particle backing 20, and then either cutting out the tile products or rolling the construction (face in or face out) for later cutting, for other processing, and/or the like. Hence, the tile products of the present invention can be made right side up or upside down as desired.

Carpet tile, carpet tiles, modular carpet tile, modular flooring, or the like of at least selected embodiments include a carpet face or show surface in overlying relation to a backing of or including adjoined particle elements. In particular, but not exclusively, the carpet tiles incorporate a carpet surface or carpet face, having, for example, a pile or non-pile surface. In one embodiment, the carpet of the carpet tile has a tuft bind or precoat layer, such as a urethane precoat, disposed in overlying relation to a resilient backing formed from a mass, mixture, or slurry, for example, of particles or crumbs, bonded together in adjoined relation by a binder. One or more optional stabilizing and/or backing layers may be included. Methods of making such carpet tiles are also provided.

In accordance with at least one embodiment of forming modular carpet tiles, granule or powder rubber crumb is mixed with binder and applied to a suitable textile surface, is cured, and then cut into the desired size for modular carpet systems. By using the flexibility of the rubber binder system, the physical properties of the backing can be optimized for selected or desired performance.

Given the stringent carpet tile performance requirement of dimensional stability with flatness, it may be preferred to add a stabilization layer to the backing. Normally this layer is a scrim or mat of fiberglass. The crumb/binder backing process can be adapted to apply two layers of crumb, interposing the scrim. The textile surface is applied and processed in, for example, a vulcanization press to form the tile material. The carpet tile composite is then cut into modular tile form.

In accordance with a selected particle backing example, a lower crumb layer is made from 2 mm mesh rubber crumb mixed with 8% binder. This is spread onto the belt at approximately 1.5 kilos per square meter. A layer of 45 g/sq.m glass scrim is laid on. An upper crumb layer is also made from 2 mm mesh rubber crumb mixed with 10% binder and is spread over the scrim. This higher level of binder is to give sufficient free binder to act as an adhesive to the carpet bottom surface and to wet out the scrim to adhere the multi-layer composite together. The carpet textile surface is laid on top. This assembly is passed through a quasi continuous vulcanization press process.

The use of rubber as the principle crumb or particle material gives advantages in flexibility and produces a tile which will lay flat and stay flatter.

The press process may be carried out at elevated temperature to speed up the curing or setting of the binder. This has the benefit of “setting” the tile structure at a relatively high temperature, for example, 120 centigrade. The thermal expansion of the rubber crumb/binder combination is slightly higher than that of the textile carpet surface and this results in a very slight doming of the tile, which may be advantageous when minimal. Also, as the tile is formed at temperatures above that of atmospheric steaming (for example after printing) the thermal stability of the tile is not de-set.

In an alternative embodiment, the textile surface can be inverted and used in place of the lower conveyor. The upper crumb layer is scattered directly onto the textile and the scrim added before the lower crumb layer is scattered. In this case, it may be optional to construct the vulcanization press upside down with the heated platen on the top and the air bag below.

The chemistry of the binder can be modified extensively, along with the size and type of rubber crumb used. For example, calcium carbonate can be added to stiffen the backing. This could be optionally added to one layer for stability and the other layer constructed of soft materials and binder to provide a cushion effect.

Other additives may include anti-flammability, anti-microbial, colour pigments, etc.

While the present invention has been illustrated and described in relation to certain potentially preferred embodiments and practices, it is to be understood that the illustrated and described embodiments and practices are illustrative only not limiting and that the present invention includes such embodiments but is not limited thereto. Rather, it is fully contemplated that modifications and variations to the present invention will no doubt occur to those of skill in the art upon reading the above description and/or through practice of the invention. For example, the particle backing of the present invention may be a preformed composite including a particle backing layer, a stabilizing layer attached to one side of the particle backing layer and a backing material attached to the other side of the particle backing layer (see FIG. 14). This three component composite backing may be laminated to a carpet face using an adhesive or tiecoat layer (see FIG. 14). It is therefore intended that the present invention shall extend to all such modifications and variations as may incorporate the broad aspects of the present invention within the full spirit and scope of the following claims and all equivalents thereto.

The words “comprises/comprising” and the words “having/including” when used herein with reference to the present invention are used to specify the presence of stated features, integers, steps or components but does not preclude the presence or addition of one or more other features, integers, steps, components of groups thereof.

It is appreciated that certain features of the invention, which, for clarity, are described in the context of separate embodiments, may also be provided in combination in a single embodiment. Conversely, various features of the invention which are, for brevity, described in the context of a single embodiment, may also be provided separately or in any suitable sub-combination.

1. A carpet tile comprising a carpet upper surface disposed in overlying relation to a single or multi-layer backing, wherein the backing comprises at least one particle backing layer of particles bonded together in adjoined relation, and wherein the particles are at least one of virgin, recycled, recyclable, renewable, bio-based, bio-degradable, and other environmentally friendly or environmentally responsible materials.

2. The invention of claim 1, further comprising a fibrous backing sheet disposed across an underside portion of the backing.

3. The invention of claim 1, wherein the carpet tile is a hardback or a cushion back carpet tile.

4. The invention of claim 1, wherein the carpet is a woven, tufted, bonded, nonwoven, knit, needled, flocked, needle punched, or the like carpet fabric.

5. The invention of claim 4, wherein the carpet is formed of natural and/or synthetic fibers or yarns.

6. The invention of claim 1, wherein the carpet has a precoat.

7. The invention of claim 6, wherein the precoat is latex, urethane, SBR, PVC, EVA, or the like.

8. The invention of claim 1, wherein the backing is resilient.

9. The invention of claim 1, wherein the backing includes a friction enhancing coating on the bottom thereof.

10. The invention of claim 1, wherein the backing is a stabilized backing.

11. The invention of claim 10, wherein the stabilized backing includes at least one stabilizing layer.

12. The invention of claim 11, wherein the stabilizing layer is a glass mat.

13. The invention of claim 1, wherein the particle backing layer includes particles and binder.

14. The invention of claim 13, wherein the binder is at least one of powder, liquid or fiber binder or adhesive material.

15. The invention of claim 13, wherein the binder is at least one of a thermoset or thermoplastic adhesive.

16. The invention of claim 13, wherein the binder is at least one of a urethane, latex, PVC, SBR, EVA, rubber, hot melt, low melt, polymer, or the like.

17. The invention of claim 13, wherein the binder bonds the particles together and the carpet to the backing.

18. The invention of claim 1, wherein the particle backing layer includes particles, binder, and at least one additive.

19. The invention of claim 1, wherein the particle backing layer includes particles selected from rubber, cork, carpet, foam, tires, wood, and/or the like.

20. The invention of claim 1, wherein the particle backing layer includes particles and a urethane MDI binder.

21. The invention of claim 1, wherein the carpet tile is aesthetically pleasing, environmentally friendly and/or environmentally responsible.

22. A method of producing a carpet tile with a carpet face or show surface and a particle backing, comprising the steps of: mixing particles, for example particles of rubber and/or foam and/or cork with adhesive or binder optionally with the addition of one or more fillers, agents or compounds; depositing the particle/binder mixture in a layer; placing an optionally precoated carpet material on the deposited particle/binder layer to form a multi-layer structure; pressing the multi-layer structure while setting the binder with, for example, heat so that the particles are consolidated to form a particle backing optionally including voids between the pressed particles, and wherein the optionally precoated carpet material is bonded to the particle backing; and, cutting the bonded composite into carpet tiles.

23. The method of claim 22, wherein the optionally precoated carpet material is at least one of printed or dyed before, during or after it is bonded to the particle backing or cut into tiles.

24. An aesthetically pleasing, environmentally friendly and/or environmentally responsible carpet tile produced by the process of claim 22.
